(19) United States
(12) Patent Application Publication
(10) Pub. No.: US 2025/0392940 A1
(43) Pub. Date: Dec. 25, 2025

(54) MEASUREMENT ACQUISITION METHOD AND DEVICE

(71) Applicant: BEIJING XIAOMI MOBILE SOFTWARE CO., LTD., Beijing (CN)

(72) Inventor: Xiaolong LI, Beijing (CN)

(73) Assignee: BEIJING XIAOMI MOBILE SOFTWARE CO., LTD., Beijing (CN)

(21) Appl. No.: 18/881,316

(22) PCT Filed: Jul. 8, 2022
(86) PCT No.: PCT/CN2022/104763

§ 371 Date: Jan. 6, 2025

(51) Int. Cl. H04W 24/10; H04L 41/16; H04W 24/02

(52) U.S. Cl. CPC H04W 24/10; H04L 41/16; H04W 24/02

(57) ABSTRACT

A method for obtaining measurement, performed by a second node, including: receiving a collection request of a first measurement sent by a first node; and sending collection feedback of the first measurement to the first node, in which the first measurement is initiated and configured by a third node and activated on the second node, and the first node is different from the third node.

### CROSS-REFERENCE TO RELATED APPLICATIONS

The present application is a U.S. National Stage of International Application No. PCT/CN2022/104763, filed on Jul. 8, 2022, the content of which is incorporated herein by reference in its entirety for all purposes.

### TECHNICAL FIELD

The present disclosure relates to the field of communication technologies, and in particular relates to a method and a device for obtaining measurement.

### BACKGROUND

In the related art, a third node initiates configuration to activate a first measurement on a second node, and the second node generates a measurement result of the first measurement, which may be reported to the third node. However, for a first node different from the third node, it is impossible to obtain measurement information activated in the second node and the generated measurement result.

### SUMMARY

According to a first aspect of embodiments of the present disclosure, there is provided a method for obtaining measurement, performed by a second node, including: receiving a collection request of a first measurement sent by a first node; and sending collection feedback of the first measurement to the first node, in which the first measurement is initiated and configured by a third node and activated on the second node, and the first node is different from the third node.

According to a second aspect of embodiments of the present disclosure, there is provided another method for obtaining measurement, performed by a first node, including: sending a collection request of a first measurement to a second node; and receiving collection feedback of the first measurement sent by the second node, in which the first measurement is initiated and configured by a third node and activated on the second node, and the first node is different from the third node.

According to a third aspect of embodiments of the present disclosure, there is provided a communication device, including a processor and a memory, the memory stores a computer program executable by the processor, and the processor is configured to perform the method of the first aspect described above.

According to a fourth aspect of embodiments of the present disclosure, there is provided a communication device, including a processor and a memory, the memory stores a computer program executable by the processor, and the processor is configured to perform the method of the second aspect described above.

### BRIEF DESCRIPTION OF THE DRAWINGS

In order to more clearly illustrate embodiments of the present disclosure or the technical solutions in the background, the following description will be given to the accompanying drawings, which are required to be used in embodiments of the present disclosure or the background.

FIG. 1 is an architectural diagram illustrating a communication system provided by an embodiment of the present disclosure;

FIG. 2 is an architectural diagram illustrating a CU-DU provided by an embodiment of the present disclosure;

FIG. 3 is a flow chart illustrating a method for obtaining measurement provided by an embodiment of the present disclosure;

FIG. 4 is a flow chart illustrating a management-based MDT activation signaling provided by an embodiment of the present disclosure;

FIG. 5 is a flow chart illustrating another method for obtaining measurement provided by an embodiment of the present disclosure;

FIG. 6 is a flow chart illustrating yet another method for obtaining measurement provided by an embodiment of the present disclosure;

FIG. 7 is a flow chart illustrating yet another method for obtaining measurement provided by an embodiment of the present disclosure;

FIG. 8 is a flow chart illustrating yet another method for obtaining measurement provided by an embodiment of the present disclosure;

FIG. 9 is a flow chart illustrating yet another method for obtaining measurement provided by an embodiment of the present disclosure;

FIG. 10 is a structural diagram illustrating a communication device provided by an embodiment of the present disclosure;

FIG. 11 is a structural diagram illustrating another communication device provided by an embodiment of the present disclosure; and

FIG. 12 is a structural diagram illustrating a chip provided by an embodiment of the present disclosure.

### DETAILED DESCRIPTION

To facilitate an understanding of the present disclosure, a brief description of some concepts related to embodiments of the present disclosure is presented herein.

### 1. Minimization of Drive Tests (MDT), e.g. a Minimization of Drive Tests Technology.

The basic idea of the technology is that operators may partially replace the traditional drive test work by performing measurement report through the contracted user's commercial terminal device, to automatically collect measurement data of the terminal device, thereby detecting and optimizing problems and faults in a wireless network. Operators generally perform routine network coverage drive tests every month, and further perform some call quality drive tests for a specific area in response to the complaints of users, and the drive tests for these scenarios may be replaced with the MDT. The measurement types of the existing MDT technology may include the following:
1). Signal level measurement: a terminal device measures a signal level of a wireless signal, and reports a measurement result to an access network device;
2). Quality of service (QOS) measurement: the QoS measurement may be performed by the access network device, for example, measurement of service traffic, service throughput, service latency and the like; the QoS measurement may also be performed by the terminal device, for example, measurement of uplink processing latency; and the QoS measurement may also be performed jointly by the access network device and the terminal device, for example, measurement of air interface latency, i.e. measuring a time from a data packet passing through a service data adaptation protocol (SDAP)/package data convergence protocol (PDCP) layer of the access network device to the arrival of the data packet at the SDAP/PDCP layer of the terminal device.
3). Accessibility measurement: the terminal device records information of a radio resource control (RRC) connection establishment failure, and reports it to the access network device.

The MDT may include a logged MDT and an immediate MDT. The immediate MDT mainly performs measurement on the terminal device in an RRC connection state (i.e., RRC_CONNECTED), and the access network device may indicate the terminal device to perform real-time measurement and reporting. The measurement may include:
Radio resource management (RRM) measurement, physical (PH) measurement, up link (UL) PDCP latency measurement, quality of experience (QoE) measurement, wireless fidelity (WiFi) measurement, Bluetooth measurement and the like. The RRM measurement may include reference signal received power (RSRP) measurement, reference signal received quality (RSRQ) measurement, received signal strength indicator (RSSI) measurement and the like. The immediate MDT is generally configured to measure data volume, internet protocol (IP) throughput rate, packet transmission latency, packet loss rate, processing latency and the like of the terminal device.

The logged MDT mainly performs measurement on a terminal device in an RRC idle state (i.e. RRC_IDLE) or a terminal device in an RRC deactivated state (i.e. RRC_INACTIVE). Each piece of logged record in a logged MDT measurement result may include a relative time stamp, an NR cell global identifier (NCGI), a measurement result of a serving cell, a measurement result of a neighboring cell, a measurement result of a wireless local area network (WLAN), a measurement result of a sensor and the like. Optionally, each piece of logged record in the logged MDT measurement result may also include location information of the terminal device. The measurement result of the serving cell may include PCI, cell RSRP/RSRQ, best beam index, RSRP/RSRQ of the best beam, number of good beams and the like. The logged MDT generally refers to measurement of received signal strength by the terminal device.

NR further defines some L2 measurements configured for the access network device to count some network performances for radio link management, radio resource management, network maintenance and other functions. These L2 measurements are counted for a terminal device, such as service throughput, service traffic, processing latency of the terminal device, air interface latency of the terminal device and the like.

The MDT measurement may be initiated in two ways:

One is a signaling based MDT (SBMDT) measurement. The signaling based MDT measurement refers to MDT measurement initiated for a specific terminal device, for example, a core network (CN) informs the access network device to initiate the MDT measurement for the specific terminal device. Regarding the signaling based MDT measurement, only in a case where a user of the terminal device agrees to perform the MDT measurement (i.e. the terminal device supports the MDT measurement), the core network will initiate a message to perform the MDT measurement for the terminal device, otherwise the core network will not initiate the message to perform the MDT measurement for the terminal device. The message of the MDT measurement generally carries information such as configuration information of the MDT measurement, an IP address or a uniform resource identifier (URI) (the URI, in computer terminology, is a string configured to identify the name of an Internet resource, the identifier allowing a user to interact with the resource in the network through a particular protocol; the most common form of URI is a uniform resource locator, and the URI is often designated as some informal web site; in still other scenarios, the URI is designated as a uniform resource name in order to provide a way to supplement a web address in an identity of a particular namespace resource) of a trace collection entity or a measurement collection entity (MCE). Configuration information of the MDT measurement may include one or more of the following: an activation type of the MDT measurement (which may include, for example, an immediate MDT only type, a logged MDT only type and an immediate MDT and Trace type, etc.), an area range of the MDT measurement, a mode of the MDT measurement (such as an immediate MDT mode or a logged MDT mode) and some configuration parameters of the mode (such as a measurement event of the immediate MDT mode, a logging interval and duration of the logged MDT mode, etc.), and a public land mobile network (PLMN) list of the signaling based MDT measurement.

The other is a management-based MDT (MBMDT) measurement. The management-based MDT measurement is not MDT measurement for the specific terminal device, but MDT measurement initiated by receiving a message to perform the MDT measurement from a OAM entity or an element manager (EM) entity by the access network device then selecting an appropriate terminal device from various terminal devices accessing the access network device based on a certain policy. For example, a certain policy may mean that the access network device only selects those terminal devices that have agreed to perform the MDT measurement for initiation of the MDT measurement. However, whether each terminal device agrees to perform the MDT measurement may be notified to the access network device by the core network in advance. For example, in a case where the user of the terminal device agrees to perform the management-based MDT, the core network may send indication information to the access network device in advance to indicate that the user of the terminal device agrees to perform the management-based MDT measurement, and in this case, the indication information may be “management-based MDT allowed indication”. Optionally, the indication information may also indicate PLMNs in which the user agrees to perform the management-based MDT, and in this case, the indication information may also be a PLMN list that agrees to perform the management-based MDT.

It should be noted that both the signaling based MDT measurement and the management-based MDT measurement described above may include the logged MDT mode and the immediate MDT mode.

For the signaling based MDT, the core network informs the access network device of MDT configuration information and the trace collection entity (TCE) IP address. The MDT configuration information may include an activation type of the MDT, an area range of the MDT, a mode of the MDT, a configuration parameter of the mode of the MDT, a PLMN list of the signaling based MDT and the like. The activation types of the MDT may include immediate MDT only, logged MDT only, immediate MDT and trace and the like. The configuration parameters of the mode of the MDT may include a measurement event of the immediate MDT, a logging interval of the logged MDT, a duration of the logged MDT and the like.

### 2. Trace Collection Entity (TCE)

The trace collection entity in embodiments of the present disclosure refers to an entity that is capable of performing trace and collection works. The trace collection entity may be a network element or a functional entity independent of the core network and the access network device, and may also be a network element or a functional entity belonging to the core network or the access network device, and the details are not limited.

In order to better understand a method and a device for obtaining measurement disclosed in embodiments of the present disclosure, a communication system to which embodiments of the present disclosure are applicable will be described below.

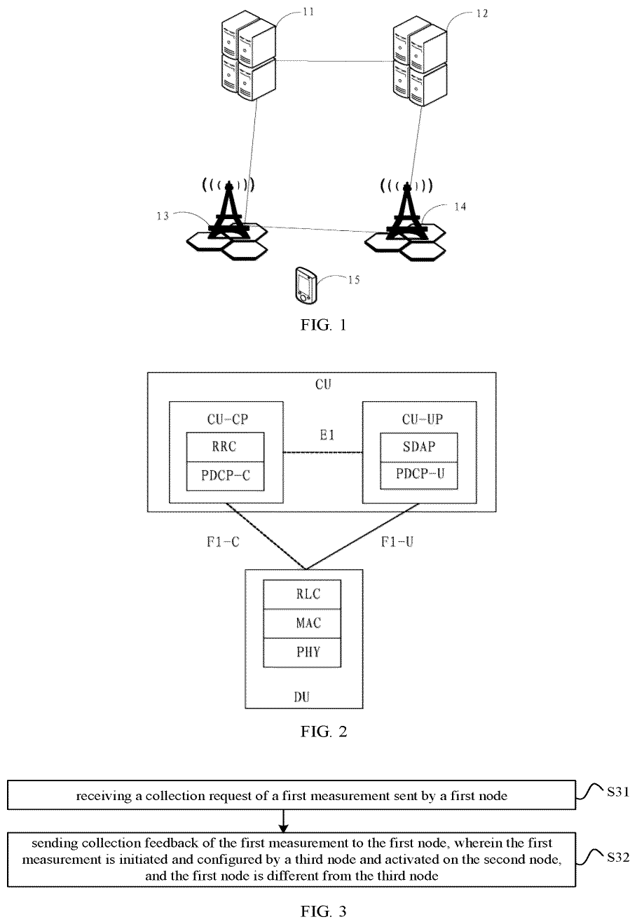

As shown in FIG. 1, embodiments of the present disclosure provides a communication system, including: a core network device (e.g., 5th generation core (5GC) 11, an evolved packet core (EPC) 12, an access network device (e.g., an evolved node B (gNB) 13, an evolved node B (eNB) 14), and a terminal device 15.

The terminal device 15, also referred to as a user equipment (UE), a mobile station (MS), a mobile terminal (MT), etc., refers to a device that provides voice and/or data connectivity to a user, for example, handheld devices and vehicle-mounted devices with wireless connection functions. At present, some examples of the terminal device include: a mobile phone, a tablet computer, a notebook computer, a palm computer, a mobile internet device (MID), a wearable device, a virtual reality (VR) device, an augmented reality (AR) device, a wireless terminal device in industrial control, and a wireless terminal device in self-driving, a wireless terminal device in remote medical surgery, a wireless terminal device in smart grid, a wireless terminal device in transportation safety, a wireless terminal device in smart city, a wireless terminal device in smart home and the like.

The core network device 11 refers to a device in a core network (CN) which provides service support for the terminal device. At present, some core network devices include: an access and mobility management function (AMF) entity, a session management function (SMF) entity, a user plane function (UPF) entity, etc. which are not to be enumerated here. The AMF entity may be responsible for access management and mobility management of the terminal device. The SMF entity may be responsible for session management, such as session setup for a user, etc. The UPF entity may be a functional entity of the user plane, primarily responsible for connecting external networks. It should be noted that, in the present disclosure, an entity may also be referred to as a network element or a functional entity, for example, an AMF entity may also be referred to as an AMF network element or an AMF functional entity, an SMF entity may also be referred to as an SMF network element or an SMF functional entity, etc.

The access network device 13 refers to a radio access network (RAN) node (or device) that accesses a terminal device to a wireless network, which may also be referred to as a base station. At present, some examples of RAN nodes include: a gNB, an eNB, a transmission reception point (TRP), a radio network controller (RNC), a node B (NB), a base station controller (BSC), a base transceiver station (BTS), a home base station (e.g. home evolved NodeB, or home node B, HNB), a base band unit (BBU), or a wireless fidelity (Wi-Fi) access point (AP), etc. Furthermore, in one network architecture, the access network device may include a centralized unit (CU), or a distributed unit (DU), or a RAN device including the CU and the DU. The RAN device including the CU and the DU splits a protocol layer from the perspective of logical functions, with the functions of some protocol layers being placed in the CU for centralized control, the functions of the remaining part or all of the protocol layers being distributed in the DU, and the DU being controlled centrally by the CU.

As shown in FIG. 2, FIG. 2 is an architectural diagram illustrating a CU-DU. The CU and the DU may be physically separated or deployed together. The CU and DU may be divided according to the protocol layer, for example, one of the possible division ways is: the CU is configured to perform functions of a radio resource control (RRC) layer, a service data adaptation protocol (SDAP) layer (this protocol layer is a protocol layer which is present in a case where the access network device is connected to a 5G core network) and a packet data convergence protocol (PDCP) layer, and the DU is configured to perform functions of a radio link control (RLC) layer, a medium access control (MAC) layer and a physical (PHY) layer, etc.

It should be understood that the above division is by way of example only and that the CU and DU may be divided in other ways. For example, the CU or the DU may be divided to have functions of more protocol layers. For example, the CU or the DU may also be divided to have some processing functions with the protocol layer.

In one possible implementation, some functions of the RLC layer and the functions of the protocol layer above the RLC layer are arranged in the CU, and the remaining functions of the RLC layer and the functions of the protocol layer below the RLC layer are arranged in the DU.

In another possible implementation, the functions of the CU or the DU may also be divided according to service types or other system requirements. For example, according to latency, the function of processing time needing to satisfy the latency requirement is arranged in the DU, and the function not needing to satisfy the latency requirement is arranged in the CU.

In yet another possible implementation, the CU may also have one or more of the functions of the core network. One or more CUs may be centrally located or may be separately located. For example, the CUs may be located on the network side to facilitate centralized management. The DU may have a plurality of radio frequency functions, or the radio frequency functions may be remotely set.

It should be understood that the functions of the CU and DU may be arranged as desired in a particular implementation, which are not limited by embodiments of the present disclosure. The function of the CU may be implemented by an entity or may be implemented by different functional entities. In one way, the function of the CU may be further divided into a control plane (CP) function and a user plane (UP) function, i.e. the CU may be divided into a CU-UP and a CU-CP. The CU-CP and the CU-UP may be implemented by different functional entities or by the same functional entity. The CU-CP and the CU-UP may be coupled with the DU, and together complete the function of the access network device. In one possible way, the CU-CP is responsible for the control plane function, and mainly includes RRC and PDCP-C. The PDCP-C is mainly responsible for the encryption and decryption of control plane data, integrity protection and data transmission, etc. The CU-UP is responsible for the user plane function and mainly includes SDAP and PDCP-U. The SDAP is mainly responsible for processing the data of the core network device and mapping a data flow to a bearer. The PDCP-U is mainly responsible for the encryption and decryption of the data plane, integrity protection, header compression, serial number maintenance and data transmission, etc. Yet another possible implementation is that the PDCP-C is also included in the CU-UP.

The core network device may communicate with the CU (e.g. the CU-UP and/or the CU-CP), for example, the CU-CP on behalf of the access network device may communicate with the core network device via an Ng interface. The CU-UP may communicate with the CU-CP via an E1 interface, for example. The CU-UP may communicate with the DU and the CU-CP may communicate with the DU, for example, the CU-CP may communicate with the DU via an F1-C (a control plane) and the CU-UP may communicate with the DU via an F1-U (a user plane). A plurality of DUs may share one CU, and one DU may be connected to a plurality of CUs (not shown in the figure). The CU and the DU may communicate via an interface (e.g. an F1 interface).

In embodiments of the present disclosure, one terminal device may communicate with a plurality of access network devices via multi-RAT dual connectivity (MR-DC). The access network device (the base station) in the MR-DC that has control plane signaling interaction with the core network is called a master node (MN), and the other base stations are called a secondary node (SN). The MN includes a master cell group (MCG), in which the MCG includes at least one PCell, and may also include at least one secondary cell (SCell), and these cells are all referred to as a MCG serving cell of the terminal device. The SN includes a secondary cell group (SCG), in which the SCG includes at least one PSCell and may also include at least one SCell, and these cells are all referred to as a SCG serving cell of the terminal device. The MCG serving cell and the SCG serving cell of the terminal device are both referred to as serving cells of the terminal device. A frequency point corresponding to each cell in the MCG is referred to as an MCG service frequency point (which may also be referred to as an MN service frequency point) of the terminal device. A frequency point corresponding to each cell in the SCG is referred to as an SCG service frequency point (which may also be referred to as an SN service frequency point) of the terminal device. These frequency points are all referred to as service frequency points of the terminal device.

For the terminal device, a plurality of access network devices constituting the MR-DC may belong to the same radio access technology (RAT), e.g. all belong to an evolved universal terrestrial radio access (E-UTRA) technology in a 4th generation (4G) communication technology or all belong to a new radio (NR) access technology in a 5G. The plurality of access network devices constituting the MR-DC may also belong to different RATs, e.g. one belongs to the E-UTRA and another belongs to the NR. The network side may use the resources of a plurality of access network devices to provide a communication service for the terminal device, thereby providing the terminal device with a high transmission rate.

It may be understood that the communication system described in embodiments of the present disclosure is for a purpose of more clearly illustrating the technical solution of embodiments of the present disclosure, which does not constitute a limitation on the technical solutions provided by embodiments of the present disclosure. Moreover, it is known by those skilled in the art that the technical solutions provided by embodiments of the present disclosure are also applicable to similar technical problems with the evolution of the system architecture and the emergence of new service scenarios.

A method and a device for obtaining measurement provided by the present disclosure will be described in detail with reference to the accompanying drawings.

Referring to FIG. 3, FIG. 3 is a flow chart illustrating a method for obtaining measurement provided by an embodiment of the present disclosure.

As shown in FIG. 3, the method is performed by a second node. The method may include but is not limited to the following steps.

In step S31, a collection request of a first measurement sent by a first node is received.

It may be understood that in the related art, a third node initiates configuration to activate the first measurement on the second node, and the second node generates a measurement result of the first measurement, which may be reported to the third node. However, for the first node different from the third node, it is impossible to obtain measurement information activated in the second node and the generated measurement result.

Based on this, in embodiments of the present disclosure, the first node may send the collection request of the first measurement to the second node to request to obtain the measurement information activated in the second node and/or the generated measurement result. In some embodiments, the collection request includes at least one of:
a start collection indication;
a stop collection indication;
time information for collection;
a cell identifier of a specific cell needing to be collected;
a measurement identifier of the first measurement needing to be collected;
a terminal device identifier of a terminal device needing to be collected;
measurement content of the first measurement needing to be collected; or a reporting manner of a measurement report.

The start collection indication or the stop collection indication is configured to indicate start or stop of collection of the measurement result of the first measurement. In a case where it is the start collection indication, the second node will start to transmit the measurement result of the first measurement to the first node; and in a case where it is the stop collection indication, the second node stops transmitting the measurement result of the first measurement to the first node.

The time information for collection is configured to indicate a time length for collection of the measurement result of the first measurement. After the second node starts to transmit the measurement result of the first measurement to the first node, the second node stops transmitting the result of the first measurement to the first node after the time information for collection expires.

The cell identifier of the specific cell needing to be collected is configured to indicate a first measurement of which specific cell needing to be collected, which may be for example a physical cell identifier (PCI) or a cell global identity (CGI).

The measurement identifier of the first measurement needing to be collected is configured to indicate an ID of the first measurement needing to be collected, for example, trace reference, or trace session recording reference and the like.

The terminal device identifier of the terminal device needing to be collected is configured to indicate the terminal device identifier of the terminal device needing to be collected may be, for example, a terminal device F1 application proposal (F1AP) ID, a terminal device E1 application proposal (E1AP) ID, a terminal device Xn application proposal (XNAP) ID, or a cell radio network temporary identify (C-RNTI) and other IDs identifying the terminal device in a radio access network.

The measurement content of the first measurement needing to be collected is configured to indicate a measurement result of content of the first measurement needing to be collected. According to an embodiment, the measurement content of the first measurement needing to be collected may be a bit map, in which each bit represents a measurement content, for example, a value of “1” represents that the measurement result corresponding to the measurement content of the first measurement needing to be collected needs to be collected by the first node, and a value of “0” represents that measurement data or measurement result corresponding to the measurement content of the first measurement needing to be collected does not need to be collected by the first node. The measurement content of the first measurement needing to be collected may include, but is not limited to, M2 (power headroom), M5 (UE average throughput), M6 (packet latency), M7 (packet loss rate), a channel quality indictor (CQI), a power headroom report (PHR), uplink (UL) interference and the like of the MDT.

The reporting manner of the measurement report is configured to indicate when the second node sends the collected first measurement report to the first node, for example, a reporting may be performed according to a preconfigured measurement period, or may be performed according to a period defined by the first node, or may be performed in a case where a session ends (for example, a reporting may be performed in a case where the bearer or terminal device context is released).

In some embodiments, information included in the collection request of the first measurement may be a list of information, each list including one or more of the above information.

The second node receives the collection request, and the second node considers the collection request and sends a measurement result of the requested first measurement to the first node. The first node sending the collection request to the second node may enable the second node to report the measurement result of the corresponding first measurement in a targeted manner, or report in a specific reporting manner, such that collection of the measurement result of the first measurement is more flexible, and unnecessary collection and signaling overhead may be reduced.

In some embodiments, the first node is a centralized unit-control plane (CU-CP) and the second node is a centralized unit-user plane (CU-UP).

In other embodiments, the first node is a master node (MN) and the second node is a secondary node (SN).

In still other embodiments, the first node is a centralized unit (CU) and the second node is a distributed unit (DU).

In some embodiments, the collection request is transmitted using a signaling message associated with the terminal device.

In embodiments of the present disclosure, the collection request of the first measurement is transmitted using the signaling message associated with the terminal device. According to an embodiment, the first node is the CU-CP, the second node is the DU, and the collection request is included in a terminal device context setup request message, a terminal device context modification request message, a terminal device context modification confirmation message, an MDT collection request message or other F1 application proposal (F1AP) messages associated with the terminal device which are sent by the CU-CP to the DU. According to another embodiment, the first node is the CU-CP, the second node is the CU-UP, and the collection request of the first measurement is included in a bearer context setup request message, a bearer context modification request message, a bearer context modification confirmation message, an MDT collection request message or other E1 application proposal (E1AP) messages associated with the terminal device which are sent by the CU-CP to the CU-UP. According to yet another embodiment, the first node is the MN in a DC scenario, the second node is the SN in the DC scenario, and the collection request of the first measurement is included in an SN addition request message, a SN modification request message, a SN modification confirmation message, an MDT collection request message, a trace collection request message, a measurement collection request message or other Xn application proposal (XnAP) messages associated with the terminal device which are sent by the MN to the SN. It should be understood that the above is merely an example, and that the first node, the second node, and the message including the collection request of the first measurement are not limited thereto.

In some embodiments, the collection request is transmitted using a signaling message not associated with the terminal device.

In embodiments of the present disclosure, the collection request of the first measurement is transmitted using the signaling message not associated with the terminal device. According to an embodiment, the first node is the CU-CP, the second node is the DU, and information of the collection request of the first measurement is included in an F1 setup response message, a GNB-CU configuration update message, a collection request message of the first measurement or other F1AP messages not associated with the terminal device which are sent by the CU-CP to the DU. According to another embodiment, the first node is the CU-CP, the second node is the CU-UP, and the collection request of the first measurement is included in a GNB-CU-CP E1 setup request message, a GNB-CU-UP E1 setup response message, a GNB-CU-CP configuration update message, a collection request message of the first measurement or other E1AP messages not associated with the terminal device which are sent by the CU-CP to the CU-UP. According to yet another embodiment, the first node is the MN in the DC scenario, the second node is the SN in the DC scenario, and the collection request of the first measurement is included in an XN setup request message, an XN setup response message, an NG-RAN node configuration update message, an NG-RAN node configuration update acknowledge message, a collection request message of the first measurement, or other XnAP messages not associated with the terminal device which are sent by the MN to the SN. It should be understood that the above is merely an example, and that the first node, the second node, and the message including the collection request of the first measurement are not limited thereto.

In some embodiments, the first measurement includes at least one of:
management-based minimization of drive tests (MDT);
cell traffic trace; or
user equipment (UE) trace.

It may be understood that the MDT may be configured to collect measurement information of the terminal device and measurement information associated with the terminal device on an access network device side. The MDT is divided into a signaling-based MDT and a management-based MDT. In a case of the management-based MDT, MDT data is collected from a terminal device in a specified area, and the area is defined as a cell list or a trace/routing/location area list. The management-based MDT is an enhancement of a management-based trace function. In a case of the signaling-based MDT, the MDT data is collected from a specific terminal device. A terminal involved in collection of the MDT data is specified using an international mobile equipment identity (IMEI) or an IMEI software version, and the signaling-based MDT is an enhancement of a signaling-based trace function.

In the case of the management-based MDT, and under a CU-DU separation architecture, the EM may send activated MDT configuration directly to the gNB-DU (hereafter referred to as the DU) or gNB-CU-CP (hereafter referred to as the CU-CP) or gNB-CU-UP (hereafter referred to as the CU-UP).

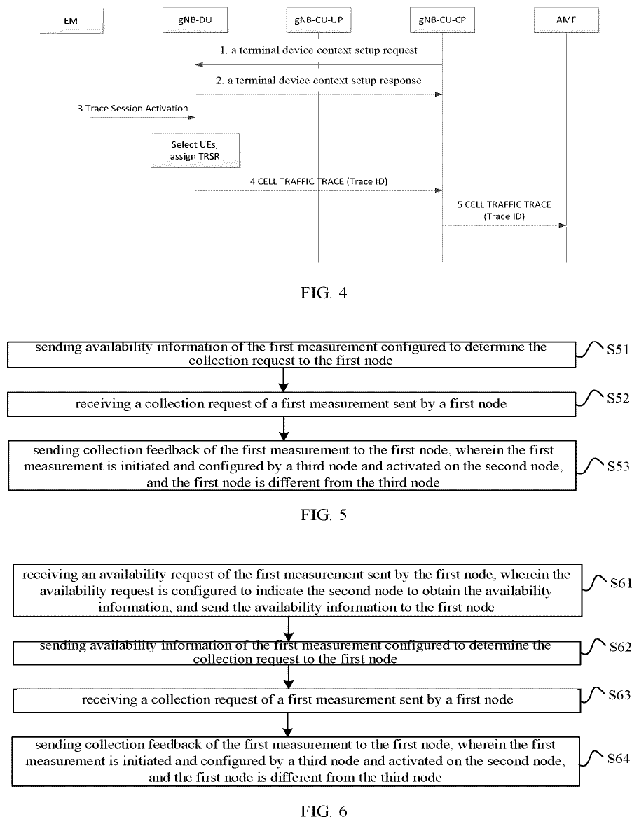

Referring to FIG. 4, FIG. 4 is a management-based MDT activation signaling flow in the gNB-DU (similar to the management-based MDT activation flow in the gNB-CU-UP).

In a case where the management-based MDT is activated in the gNB-DU (as shown in step 3), and the terminal device is selected to perform the MDT, and in a case where there is an anonymization parameter set to be an international mobile equipment identity-type allocation code (IMEI-TAC), the gNB-DU will send cell trace traffic to the gNB-CU-CP to inform the gNB-CU-CP of an trace ID of the selected terminal device (as shown in step 4), such that the gNB-CU-CP informs a core network (as shown in step 5). The core network then associates the terminal device ID with the trace ID and sends it to a TCE. Otherwise, the gNB-DU does not send any information about the MDT to the gNB-CU-CP. However, after collecting the MDT, the gNB-DU will send an MDT report, a cell traffic trace report or a terminal device trace report to the TCE, such that the TCE may perform further analysis on the measurement result. However, regarding the CU-CP, the whole process is unknown, that is, the CU-CP does not know start of the MDT measurement and specific measurement contents by the DU or the CU-UP (it should be noted that the fourth step in FIG. 4 may or may not occur, and even if it occurs, it is not known which type of measurement is performed). Therefore, in the related art it is not supported that the CU-CP obtains the measurement information and the measurement result of the MDT from the DU or the CU-UP.

In embodiments of the present disclosure, the first node (CU-CP) may send the collection request of the first measurement (MDT) to the second node (CU-UP), and may request to obtain the measurement information and the measurement result of the MDT.

In embodiments of the present disclosure, the first node (CU) may send the collection request of the first measurement (MDT) to the second node (DU), and may request to obtain the measurement information and the measurement result of the MDT.

Of course, in the related art, in a case where the management-based MDT is directly activated in the SN by the OAM, and the MN is not supported to obtain the measurement information and the measurement result of the MDT from the SN, in embodiments of the present disclosure, the first node (MN) may send the collection request of the first measurement (MDT) to the second node (SN), and may request to obtain the measurement information and the measurement result of the MDT.

Furthermore, in embodiments of the present disclosure, the first measurement may also be a cell traffic trace, in which the cell traffic trace is activated in the second node. The first node may send a collection request of the cell traffic trace to the second node, and may request to obtain measurement information and a measurement result of the cell traffic trace. The first node is the CU-CP and the second node is the CU-UP, or the first node is the CU and the second node is the DU, or the first node is the MN and the second node is the SN.

In embodiments of the present disclosure, the first measurement may also be a user equipment (UE) trace, in which the user equipment (UE) trace is activated in the second node. The first node may send a collection request of the user equipment (UE) trace to the second node, and may request to obtain measurement information and a measurement result of the user equipment (UE) trace. The first node is the CU-CP and the second node is the CU-UP, or the first node is the CU and the second node is the DU, or the first node is the MN and the second node is the SN.

In step S32, collection feedback of the first measurement is sent to the first node, in which the first measurement is initiated and configured by the third node and activated on the second node, and the first node is different from the third node.

In embodiments of the present disclosure, the second node may send the collection feedback of the first measurement to the first node after receiving the collection request of the first measurement sent by the first node.

The first measurement is initiated and configured by the third node and activated on the second node. The third node may be operation, administration and maintenance (OAM) or element manager (EM).

In some embodiments, the collection feedback includes a measurement report of the first measurement, and the measurement report includes at least one of:
a measurement identifier corresponding to the measurement result;
a terminal device identifier of a terminal device corresponding to the measurement result;
a measurement result;
a cell identifier of a specific cell corresponding to the measurement result;
a measurement start time corresponding to the measurement result; or
a measurement end time corresponding to the measurement result.

In embodiments of the present disclosure, the second node sends the collection feedback of the first measurement to the first node, in which the collection feedback includes one or more measurement results of the first measurement (or may also be referred to as a measurement report, e.g. an MDT report, a cell traffic trace report, or a user equipment trace report).

The measurement report includes the measurement identifier corresponding to the measurement result configured to indicate a first measurement ID, for example, a trace ID, corresponding to the measurement result in the measurement report.

The measurement report includes the terminal device identifier of the terminal device corresponding to the measurement result configured to indicate the terminal device corresponding to the measurement result in the measurement report, for example, a terminal device F1AP ID, a terminal device E1AP ID, a terminal device XNAP ID or the C-RNTI and other IDs identifying the terminal device in the radio access network.

The measurement report includes the measurement result, for example, the MDT report, the cell traffic trace report or the user equipment trace report, and the measurement result may include measurement results of one or more measurement contents and/or a time when the measurement report is generated.

The measurement report includes the cell identifier of the specific cell corresponding to the measurement result configured to indicate which cell the first measurement being fed back belongs to, which may be the PCI or the CGI, for example.

The measurement report includes the measurement start time corresponding to the measurement result and/or the measurement end time corresponding to the measurement result configured to indicate a start time and/or an end time of the corresponding measurement in the measurement result of the first measurement, which may for example be in a form of a time stamp. The first node may analyze overall data collection by correlating measurement information from other nodes through a specific measurement time.

In some embodiments, the collection feedback is transmitted using the signaling message associated with the terminal device.

In some embodiments, the collection feedback is transmitted using the signaling message not associated with the terminal device.

In embodiments of the present disclosure, the collection feedback of the first measurement is transmitted using the signaling message associated with the terminal device or the signaling message not associated with the terminal device. According to an embodiment, the first node is the CU-CP, the second node is the DU, and the collection feedback of the first measurement is included in a collection feedback message of the first measurement, the MDT report, the cell traffic trace report or the user equipment trace report or other F1AP messages which are sent by the DU to the CU-CP. According to another embodiment, the first node is the CU-CP, the second node is the CU-UP, and the collection feedback of the first measurement is included in the collection feedback message of the first measurement, the MDT report, the cell traffic trace report or the user equipment trace report or other E1AP messages which are sent by the CU-UP to the CU-CP. According to yet another embodiment, the first node is the MN in the DC scenario, the second node is the SN in the DC scenario, and the collection feedback of the first measurement is included in the collection feedback message of the first measurement, the MDT report, the cell traffic trace report or the user equipment trace report or other XnAP messages which are sent by the MN to the SN. It should be understood that the above is merely an example, and that the first node, the second node, and the message including the collection feedback are not limited thereto.

In TR 37.817, under the CU-DU separation architecture, training and reasoning of an AI model are performed in the gNB-CU. In the DC scenario, the training and reasoning of the AI model are performed in the MN, and the measurement information associated with the terminal device will be used as input of the training and reasoning of the AI model or performance feedback of the AI model. The measurement information associated with the terminal device may be implemented by using the MDT measurement in the related art.

In a case where the training and reasoning of the AI model are in the CU-CP or the MN, according to a trace/MDT mechanism in the related art, and the managed trace/MDT is activated in the DU or the CU-UP or in the SN, the DU or the CU-UP or the SN starts measurement after selecting the terminal device, and directly sends the MDT report, the cell traffic trace report or the user equipment trace report to the OAM (e.g., the TCE in the OAM). The CU-CP is unaware of this process, that is, the CU-CP does not know start of the MDT measurement and the specific measurement content by the DU or the CU-UP (for example, the fourth step in FIG. 4 may or may not occur, and even if it occurs, it is not known which type of measurement is performed). Therefore, the trace/MDT mechanism does not support the CU-CP to obtain the measurement information and the measurement result of the MDT from the DU or the CU-UP, and the existing trace/MDT mechanism also does not support the MN to obtain the measurement information and the measurement result of the trace/MDT from the SN.

Based on this, in embodiments of the present disclosure, in a case where the management-based MDT is activated on the second node, the first node, as the node responsible for the training or reasoning of the AI model, needs to collect an MDT measurement report from the second node. By means of the method provided in embodiments of the present disclosure, the second node may be enabled to select the terminal device to perform the MDT measurement in the targeted manner considering that the first node has a requirement of AI collection, and the first node may also be enabled to obtain detailed information of the MDT activated on the second node in time, for example, whether it is configured or activated, and information of the specific configured or activated MDT measurement content, and/or the MDT measurement report needing to be collected, such that MDT measurement data may be selected and collected in the target manner for AI-related operations.

In the CU-DU separation architecture, the first node is the CU or the CU-CP, and the second node is the DU or the CU-UP. In the dual connectivity scenario, the first node is the MN, and the second node is the SN.

In embodiments of the present disclosure, the first node receives the collection feedback. In some embodiments, the first node uses the collection feedback as input for model training, model reasoning, and/or model performance feedback to enable the model training, the model reasoning and the like more accurate. The model may be the artificial intelligence (AI) model, thereby enabling the access network device to make better load balancing, network energy saving and/or mobility optimization decisions, improving user experience, and reducing network energy consumption.

By implementing embodiments of the present disclosure, under the CU-DU or CP-UP separation architecture or the dual connectivity scenario, a node performing the training or reasoning and/or performance feedback of the AI model may be enabled to obtain information about whether the terminal device measurement is available on other nodes and/or collect the measurement information of the terminal device on other nodes, and the method may enable data collection of the training or reasoning and/or the performance feedback of the AI model to be diverse, flexible and targeted, thereby enabling the training and/or reasoning of the AI model to be more accurate. A better network optimization scheme may be implemented through a more accurate AI model, for example, load balancing, network energy saving, mobility optimization and the like, which may not only ensure or improve the user experience, improve the user loyalty and thus improve the operating revenue, but also save the network energy consumption and reduce the cost of operators.

By implementing embodiments of the present disclosure, the second node receives the collection request of the first measurement sent by the first node, and sends the collection feedback of the first measurement to the first node, in which the first measurement is initiated and configured by the third node and activated on the second node, and the first node is different from the third node. Therefore, the first node may obtain the information of the first measurement activated in the second node, and the measurement result of the first measurement.

It may be understood that, in the CU-DU separation architecture, the first node is the CU, the second node is the DU, the trace is configured to the DU by the OAM through the CU, and the CU may know a measurement content about the trace (the cell traffic trace and/or the user equipment (UE) trace) in the DU. In this case, the CU may directly send the collection request of the measurement of the trace to the DU, and then receive the collection feedback sent by the DU to obtain the measurement information and/or the measurement result of the trace.

In a case where the first node is the CU, the second node is the DU, and the first measurement is the management-based MDT, the second node may send availability information of the first measurement configured to determine the collection request to the first node in advance, such that the first node may obtain the availability information of the first measurement, then select a specific terminal device and/or a specific measurement content in a targeted manner to collect the measurement result, and send the collection request to the second node.

Furthermore, for the first case: the first node is the CU-CP, the second node is the CU-UP, and the first measurement is the management-based MDT; for the second case: the first node is the CU-CP, the second node is the CU-UP, and the first measurement is the trace (the cell traffic trace and/or the user equipment (UE) trace); for the third case: the first node is the MN, the second node is the SN, and the first measurement is the management-based MDT; for the fourth case: the first node is the MN, the second node is the SN, and the first measurement is the trace (the cell traffic trace and/or the user equipment (UE) trace). The second node may send the availability information of the first measurement configured to determine the collection request to the first node in advance, such that the first node may obtain the availability information of the first measurement, and then select the specific terminal device and/or the specific measurement content in the targeted manner to collect the measurement result, and send the collection request to the second node.

In some embodiments, the second node sends the availability information of the first measurement configured to determine the collection request to the first node.

It may be understood that, before receiving the collection request of the first measurement sent by the first node, the second node may send the availability information of the first measurement to the first node to indicate the availability information of the first measurement that may be obtained. Therefore, the first node may determine the collection request to send to the second node according to the availability information.

In some embodiments, the availability information includes at least one of:
a start indication of the first measurement being activated;
a stop indication of the first measurement being activated;
a cell identifier of a specific cell corresponding to information fed back by the first measurement being activated;
a measurement identifier of the first measurement being activated;
a terminal device identifier of the terminal device for which the first measurement is activated; or
content information of the first measurement being activated.

The start indication of the first measurement being activated or the stop indication of the first measurement being activated is configured to indicate a specific status of the first measurement, such as a start or stop indication.

The cell identifier of the specific cell corresponding to the information fed back by the first measurement being activated is configured to indicate which specific cell the feedback information belongs to, which may be the PCI or the CGI, for example.

The measurement identifier of the first measurement being activated is configured to indicate the ID of the first measurement, for example, the trace ID, trace reference, or trace session recording reference and the like.

The terminal device identifier of the terminal device for which the first measurement is activated is configured to indicate the terminal device for which the first measurement is activated. For example, it may be the terminal device F1AP ID, the terminal device E1AP ID, the terminal device XNAP ID or C-RNTI and other IDs identifying the terminal device in the radio access network.

The content information of the first measurement being activated is configured to indicate the content for which the first measurement is activated. According to an embodiment, the content information of the first measurement being activated may be the bit map, in which each bit represents a measurement content, for example, a value of “1” represents that the content information of the first measurement being activated is activated, and a value of “0” represents that the content information of the first measurement being activated is not activated. The content information of the first measurement being activated may include, but is not limited to, the M2 (power headroom), the M5 (UE average throughput), the M6 (packet latency), the M7 (packet loss rate), the channel quality indictor (CQI), the power headroom report (PHR), the uplink (UL) interference and the like of the MDT.

In some embodiments, information included in the availability information of the first measurement may be a list of information, each list including one or more of the above information.

The AI-related operations may be the training of the AI model, the reasoning of the AI model and/or the performance feedback of the AI model and the like.

In some embodiments, the availability information is transmitted using the signaling message associated with the terminal device.

In embodiments of the present disclosure, the availability information of the first measurement is transmitted using the signaling message associated with the terminal device. According to an embodiment, the first node is the CU-CP, the second node is the DU, and the availability information of the first measurement is included in a terminal device context setup feedback message, a terminal device context modification feedback message, a terminal device context modification requirement message, an MDT availability feedback message, a cell service trace message or other F1AP messages associated with the terminal device which are sent by the DU to the CU-CP. According to another embodiment, the first node is the CU-CP, the second node is the CU-UP, and the availability information of the first measurement is included in a bearer context setup feedback message, a bearer context modification feedback message, a bearer context modification requirement message, a cell service trace message or other E1AP messages associated with the terminal device which are sent by the CU-CP to the CU-UP. According to yet another embodiment, the first node is the MN in the DC scenario, the second node is the SN in the DC scenario, and the availability information of the first measurement is included in an SN addition request confirmation message, a SN modification confirmation message, a SN modification requirement, a cell service trace message or other XnAP messages associated with the terminal device which are sent by the MN to the SN. It should be understood that the above is merely an example, and that the first node, the second node, and the message including the availability information of the first measurement are not limited thereto.

In some embodiments, the availability information is transmitted using the signaling message not associated with the terminal device.

In some embodiments, the availability information of the first measurement is transmitted using the signaling message not associated with the terminal device. According to an embodiment, the first node is the CU-CP, the second node is the DU, and information of the availability information of the first measurement is included in an F1 setup request message, a GNB-DU configuration update message, an availability information message of the first measurement or other F1AP messages not associated with the terminal device which are sent by the DU to the CU-CP. According to another embodiment, the first node is the CU-CP, the second node is the CU-UP, and the availability request of the first measurement is included in a GNB-CU-UP E1 setup request message, a GNB-CU-CP E1 setup response message, a GNB-CU-UP configuration update message, a collection request message of the first measurement or other E1AP messages not associated with the terminal device which are sent by the CU-UP to the CU-CP. According to yet another embodiment, the first node is the MN in the DC scenario, the second node is the SN in the DC scenario, and the availability information of the first measurement is included in an XN setup request message, an XN setup response message, an NG-RAN node configuration update message, an NG-RAN node configuration update acknowledge message, a collection request message of the first measurement or other XnAP messages not associated with the terminal device which are sent by the MN to the SN. It should be understood that the above is merely an example, and that the first node, the second node, and the message including the availability information of the first measurement are not limited thereto.

In embodiments of the present disclosure, the first node receives the availability information and may select the content of the first measurement needing to be collected according to the availability information and/or its own collection requirement. The second node sends the availability information to the first node. The first node may consider the availability information and select a specific terminal device and/or a specific measurement content in a more targeted manner to collect the measurement result for the AI-related operations, thereby avoiding unnecessary measurement information collection and additional signaling overhead.

In a case where the first node is the CU, the second node is the DU, and the first measurement is the management-based MDT, the second node may send the availability information of the first measurement configured to determine the collection request to the first node in advance, such that the first node may obtain the availability information of the first measurement, then select the specific terminal device and/or the specific measurement content in a targeted manner to collect the measurement result, and send the collection request to the second node. Moreover, the second node may send the availability information to the first node in response to an availability request of the first node.

Furthermore, for the first case: the first node is the CU-CP, the second node is the CU-UP, and the first measurement is the management-based MDT; for the second case: the first node is the CU-CP, the second node is the CU-UP, and the first measurement is the trace (the cell traffic trace and/or the user equipment (UE) trace); for the third case: the first node is the MN, the second node is the SN, and the first measurement is the management-based MDT; for the fourth case: the first node is the MN, the second node is the SN, the first measurement is the trace (the cell traffic trace and/or the user equipment (UE) trace). The second node may send the availability information of the first measurement configured to determine the collection request to the first node in advance, such that the first node may obtain the availability information of the first measurement, and then select the specific terminal device and/or specific measurement content in a targeted manner to collect the measurement result, and send the collection request to the second node. Moreover, the second node may send the availability information to the first node in response to the availability request of the first node.

In some embodiments, the second node receives the availability request of the first measurement sent by the first node, in which the availability request is configured to indicate the second node to obtain the availability information and send the availability information to the first node.

In embodiments of the present disclosure, the first node sends the availability request of the first measurement to the second node, in which the availability request is configured to indicate the second node to obtain the availability information and feed it back to the first node.

In some embodiments, the availability request includes at least one of:
information indicating measurement availability information;
indicating that the first node has an artificial intelligence (AI) function;
indicating that the artificial intelligence (AI) function of the first node is turned on;
indicating that the artificial intelligence (AI) function of the first node is turned off; or
a feedback condition of measurement availability information.

The availability request may include a first indication configured to request the availability information, indicate that the first node needs to collect the first measurement, indicate that the first node has the AI function (for example, the training of the AI model and the reasoning of the AI model), and indicate that the AI function of the first node is turned on, or indicate that the AI function of the first node is turned off.

According to an embodiment, display information of the first indication is true, that is, which means that the first node needs to collect the availability information of the first measurement of the terminal device. In a case where the first indication is present, the second node receives and stores the first indication. According to an embodiment, in a case where a second measurement of the terminal device is not activated, and the second node receives an activation request of the first measurement from the third node, the second node may consider the first indication to decide whether to select the terminal device to perform the first measurement, and/or the second node sends the availability information of the first measurement to the first node. According to another embodiment, the second node sends the availability information of the first measurement to the first node in a case where the first measurement of the terminal device has been activated. It should be understood that the above is merely an example, and the operations performed by the second node considering the first indication are not limited thereto. The third node may be an OAM or an EM.

The availability request includes the feedback condition of the measurement availability information configured to indicate a condition for requesting the availability information of the first measurement, and the second node needs to feedback the requested information only in a case where the condition is satisfied. According to an embodiment, the feedback condition may be a specific measurement content, for example, the M2 (power headroom), the M5 (UE average throughput), the M6 (packet latency), the M7 (packet loss rate), the channel quality indictor, the power headroom report, the uplink interference and the like in the MDT. In a case where the second node is configured with the same measurement content, the second node needs to feed back information of the configured first measurement and/or a result of the first measurement to the first node. According to another embodiment, the feedback condition may be cell information, network slice, the terminal device ID and other information, indicating that the first node only requests the availability information of the first measurement corresponding to the cell, network slice, and/or specific terminal device.

In some embodiments, the availability request is transmitted using the signaling message associated with the terminal device.

In embodiments of the present disclosure, the availability request of the first measurement is transmitted using the signaling message associated with the terminal device. According to an embodiment, the first node is the CU-CP, the second node is the DU, and the availability request of the first measurement is included in a terminal device context setup request message, a terminal device context modification request message, a terminal device context modification confirmation message or other F1AP messages associated with the terminal device which are sent by the CU-CP to the DU. According to another embodiment, the first node is the CU-CP, the second node is the CU-UP, and the availability request of the first measurement is included in a bearer context setup request message, a bearer context modification request message, a bearer context modification confirmation message or other E1AP messages associated with the terminal device which are sent by the CU-CP to the CU-UP. According to yet another embodiment, the first node is the MN in the DC scenario, the second node is the SN in the DC scenario, and the availability request of the first measurement is included in an SN addition request message, an SN modification request message, an SN modification confirmation message or other XnAP messages associated with the terminal device which are sent by the MN to the SN. It should be understood that the above is merely an example, and that the first node, the second node, and the message including the availability request of the first measurement are not limited thereto. The first measurement may be MDT measurement, but is not limited thereto.

In some embodiments, the availability request is transmitted using the signaling message not associated with the terminal device.

In embodiments of the present disclosure, the availability request of the first measurement is transmitted using the signaling message not associated with the terminal device. According to an embodiment, the first node is the CU-CP, the second node is the DU, and information of the availability request of the first measurement is included in an F1 setup response message, a GNB-CU configuration update message, a collection request message of the first measurement or other F1AP messages not associated with the terminal device which are sent by the CU-CP to the DU. According to another embodiment, the first node is the CU-CP, the second node is the CU-UP, and the availability request of the first measurement is included in a GNB-CU-CP E1 setup request message, a GNB-CU-UP E1 setup response message, a GNB-CU-CP configuration update message, a collection request message of the first measurement or other E1AP messages not associated with the terminal device which are sent by the CU-CP to the CU-UP. According to yet another embodiment, the first node is the MN in the DC scenario, the second node is the SN in the DC scenario, and the availability request of the first measurement is included in an XN setup request message, an XN setup response message, an NG-RAN node configuration update message, an NG-RAN node configuration update acknowledge message, the collection request message of the first measurement or other XnAP messages not associated with the terminal device which are sent by the MN to the SN. It should be understood that the above is merely an example, and that the first node, the second node, and the message including the availability request of the first measurement are not limited thereto.

In embodiments of the present disclosure, the second node receives and stores the availability request of the first measurement, and sends the availability information of the first measurement to the first node according to an activation situation of the first measurement. The first node sends the availability request of the first measurement to the second node. The second node may consider the availability request and select the terminal device or a terminal device under a specific condition in a targeted manner to perform the first measurement. Moreover, once the first measurement is activated, the second node may report to the first node more promptly such that the first node decides how to collect the content of the measurement report of the first measurement for the AI-related operation.

In embodiments of the present disclosure, the second node sends the availability information to the first node in response to the availability request of the first measurement sent by the first node. Alternatively, the second node sends the availability information to the first node according to configuration of the second node itself (for example, configured through the OAM or according to a protocol agreement).

It may be understood that the second node sends the availability information of the first measurement to the first node in a case where the first measurement has been activated on the second node. Therefore, the first node may select the specific terminal device and/or the specific measurement content in a more targeted manner to collect the measurement result according to the availability information for the AI-related operation, thereby avoiding unnecessary measurement information collection and additional signaling overhead.

In embodiments of the present disclosure, the first node sends the availability request of the first measurement to the second node, which may be sent before the first measurement is activated on the second node, or may also be sent after the first measurement is activated on the second node. That is, in one case: the third node initiates the configuration to the second node, the first measurement is activated on the second node, and then the first node sends the availability request of the first measurement to the second node. In another case, the first node sends the availability request of the first measurement to the second node. Since the first measurement is not activated at this time, the second node does not send the availability information of the first measurement to the first node. In a case of receiving the configuration for activating the first measurement sent by the third node, the second node decides whether to select the terminal device to perform the first measurement according to the availability request of the first measurement. For example, in a case where the availability request includes the signaling message associated with the terminal device for transmission, the terminal device is selected to perform the first measurement, and then the relevant information of the first measurement is obtained, and the availability information of the first measurement is sent to the first node.

Referring to FIG. 5, FIG. 5 is a flow chart illustrating another method for obtaining measurement provided by an embodiment of the present disclosure.

As shown in FIG. 5, the method is performed by a second node. The method may include but is not limited to the following steps.

In step S51, availability information of a first measurement configured to determine a collection request is sent to a first node.

It may be understood that, before receiving the collection request of the first measurement sent by the first node, the second node may send the availability information of the first measurement to the first node to indicate the availability information of the first measurement that may be obtained. Therefore, the first node may determine the collection request sent to the second node according to the availability information.

In some embodiments, the availability information includes at least one of:
a start indication of the first measurement being activated;
a stop indication of the first measurement being activated;
a cell identifier of a specific cell corresponding to information fed back by the first measurement being activated;
a measurement identifier of the first measurement being activated;
a terminal device identifier of the terminal device for which the first measurement is activated; or
content information of the first measurement being activated.

The relevant description of the availability information may refer to the relevant description in above embodiments, and will not be described again here.

In some embodiments, the availability information is transmitted using a signaling message associated with the terminal device.

In some embodiments, the availability information is transmitted using a signaling message not associated with the terminal device.

The relevant description of transmission manner of the availability information may refer to the relevant description in above embodiments, and will not be described again here.

In embodiments of the present disclosure, the first node receives the availability information and may select the content of the first measurement needing to be collected according to the availability information and/or its own collection requirement. The second node sends the availability information to the first node. The first node may consider the availability information and select a specific terminal device and/or a specific measurement content in a more targeted manner to collect the measurement result for the AI-related operation, thereby avoiding unnecessary measurement information collection and additional signaling overhead.

In step S52, the collection request of the first measurement sent by the first node is received.

In step S53, collection feedback of the first measurement is sent to the first node, in which the first measurement is initiated and configured by a third node and activated on the second node, and the first node is different from the third node.

In embodiments of the present disclosure, the relevant descriptions of S52 and S53 may refer to the relevant descriptions in above embodiments, and will not be described again here.

By implementing embodiments of the present disclosure, the second node sends the availability information of the first measurement configured to determine the collection request to the first node, receives the collection request of the first measurement sent by the first node, and sends the collection feedback of the first measurement to the first node, in which the first measurement is initiated and configured by the third node and activated on the second node, and the first node is different from the third node. Therefore, the first node may obtain information of the first measurement activated in the second node and a measurement result of the first measurement.

Referring to FIG. 6, FIG. 6 is a flow chart illustrating yet another method for obtaining measurement provided by an embodiment of the present disclosure.

As shown in FIG. 6, the method is performed by a second node. The method may include but is not limited to the following steps.

In step S61, an availability request of a first measurement sent by a first node is received, in which the availability request is configured to indicate the second node to obtain availability information, and send the availability information to the first node.

In embodiments of the present disclosure, the first node sends the availability request of the first measurement to the second node, in which the availability request is configured to indicate the second node to obtain the availability information and feed it back to the first node.

In some embodiments, the availability request includes at least one of:
information indicating measurement availability information;
indicating that the first node has an artificial intelligence (AI) function;
indicating that the artificial intelligence (AI) function of the first node is turned on;
indicating that the artificial intelligence (AI) function of the first node is turned off; or
a feedback condition of measurement availability information.

The relevant description of the availability request may refer to the relevant description in above embodiments, and will not be described again here.

In some embodiments, the availability request is transmitted using a signaling message associated with the terminal device.

In some embodiments, the availability request is transmitted using a signaling message not associated with the terminal device.

The relevant description of transmission manner of the availability request may refer to the relevant description in above embodiments, and will not be described again here.

In embodiments of the present disclosure, the second node receives and stores the availability request of the first measurement, and sends the availability information of the first measurement to the first node according to an activation situation of the first measurement. The first node sends the availability request of the first measurement to the second node. The second node may consider the availability request and select the terminal device or a terminal device under a specific condition in a targeted manner to perform the first measurement. Moreover, once the first measurement is activated, the second node may report to the first node more promptly such that the first node decides how to collect the content of the measurement report of the first measurement for the AI-related operation.

In embodiments of the present disclosure, the second node sends the availability information to the first node in response to the availability request of the first measurement sent by the first node. Alternatively, the second node sends the availability information to the first node according to configuration of the second node itself (for example, configured through the OAM or according to a protocol agreement).

In step S62, the availability information of the first measurement configured to determine the collection request is sent to the first node.

In step S63, the collection request of the first measurement sent by the first node is received.

In step S64, collection feedback of the first measurement is sent to the first node, in which the first measurement is initiated and configured by a third node and activated on the second node, and the first node is different from the third node.

In embodiments of the present disclosure, the relevant descriptions of S62 to S64 may refer to the relevant descriptions in above embodiments, and will not be described again here.

By implementing embodiments of the present disclosure, the second node receives the availability request of the first measurement sent by the first node, in which the availability request is configured to indicate the second node to obtain the availability information and send the availability information to the first node. The second node sends the availability information of the first measurement configured to determine the collection request to the first node. The second node receives the collection request of the first measurement sent by the first node. The second node sends the collection feedback of the first measurement to the first node, in which the first measurement is initiated and configured by the third node and activated on the second node, and the first node is different from the third node. Therefore, the first node may obtain information of the first measurement activated in the second node and a measurement result of the first measurement.

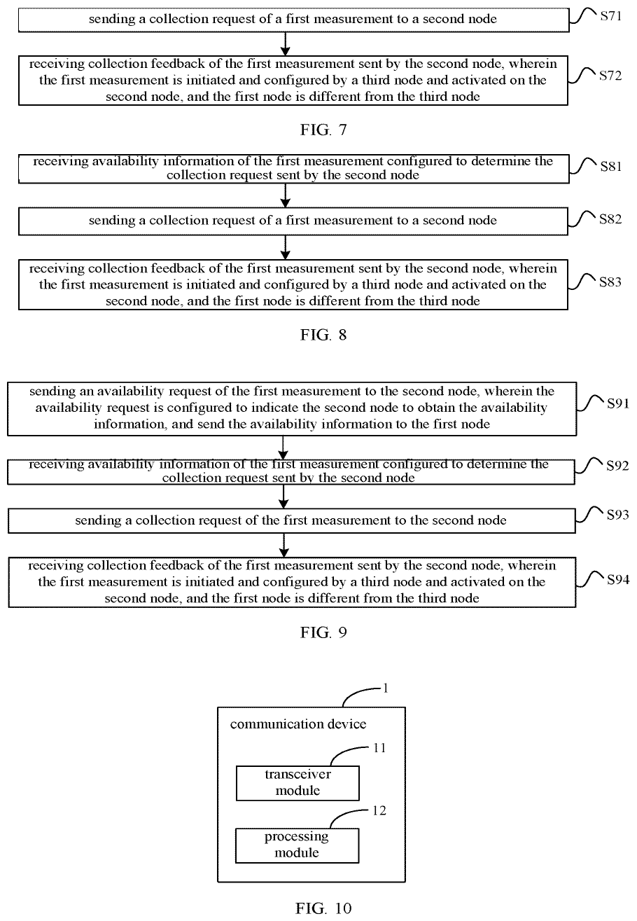

Referring to FIG. 7, FIG. 7 is a flow chart illustrating yet another method for obtaining measurement provided by an embodiment of the present disclosure.

As shown in FIG. 7, the method is performed by a first node. The method may include but is not limited to the following steps.

In step S71, a collection request of a first measurement is sent to a second node.

It may be understood that in the related art, a third node initiates configuration to activate the first measurement on the second node, and the second node generates a measurement result of the first measurement, which may be reported to the third node. However, for the first node different from the third node, it is impossible to obtain measurement information activated in the second node and the generated measurement result.

Based on this, in embodiments of the present disclosure, the first node may send the collection request of the first measurement to the second node to request to obtain the measurement information activated in the second node and/or the generated measurement result.

In some embodiments, the collection request includes at least one of:
a start collection indication;
a stop collection indication;
time information for collection;
a cell identifier of a specific cell needing to be collected;
a measurement identifier of the first measurement needing to be collected;
a terminal device identifier of a terminal device needing to be collected;
measurement content of the first measurement needing to be collected; or
a reporting manner of a measurement report.

The start collection indication or the stop collection indication is configured to indicate start or stop of collection of the measurement result of the first measurement. In a case where it is the start collection indication, the second node will start to transmit the measurement result of the first measurement to the first node; and in a case where it is the stop collection indication, the second node stops transmitting the measurement result of the first measurement to the first node.

The time information for collection is configured to indicate a time length for collection of the measurement result of the first measurement. After the second node starts to transmit the measurement result of the first measurement to the first node, the second node stops transmitting the measurement result of the first measurement to the first node after the time information for collection expires.

The cell identifier of the specific cell needing to be collected is configured to indicate a first measurement of which specific cell needing to be collected, which may be for example a physical cell identifier (PCI) or a cell global identity (CGI).

The measurement identifier of the first measurement needing to be collected is configured to indicate an ID of the first measurement needing to be collected, for example, trace reference, or trace session recording reference and the like.

The terminal device identifier of the terminal device needing to be collected is configured to indicate the terminal device identifier of the terminal device needing to be collected may be, for example, a terminal device F1 application proposal (F1AP) ID, a terminal device E1 application proposal (E1AP) ID, a terminal device Xn application proposal (XNAP) ID, or a cell radio network temporary identify (C-RNTI) and other IDs identifying the terminal device in a radio access network.

The measurement content of the first measurement needing to be collected is configured to indicate a measurement result of content of the first measurement needing to be collected. According to an embodiment, the measurement content of the first measurement needing to be collected may be a bit map, in which each bit represents a measurement content, for example, a value of “1” represents that the measurement result corresponding to the measurement content of the first measurement needing to be collected needs to be collected by the first node, and a value of “0” represents that measurement data or measurement result corresponding to the measurement content of the first measurement needing to be collected does not need to be collected by the first node. The measurement content of the first measurement needing to be collected may include, but is not limited to, M2 (power headroom), M5 (UE average throughput), M6 (packet latency), M7 (packet loss rate), a channel quality indictor, a power headroom report, uplink interference and the like of the MDT.

The reporting manner of the measurement report is configured to indicate when the second node sends the first measurement report collected to the first node, for example, a reporting may be performed according to a preconfigured measurement period, or may be performed according to a period defined by the first node, or may be performed in a case where a session ends (for example, a reporting may be performed in a case where the terminal device or bearer context is released).

In some embodiments, information included in the collection request of the first measurement may be a list of information, each list including one or more of the above information.

The second node receives the collection request, and the second node considers the collection request and sends a measurement result of the requested first measurement to the first node. The first node sending the collection request to the second node may enable the second node to report the measurement result of the corresponding first measurement in a targeted manner, or report in a specific reporting manner, such that collection of the measurement result of the first measurement is more flexible, and unnecessary collection and signaling overhead may be reduced.

In some embodiments, the first node is a centralized unit-control plane (CU-CP) and the second node is a centralized unit-user plane (CU-UP).

In other embodiments, the first node is a master node (MN) and the second node is a secondary node (SN).

In still other embodiments, the first node is a centralized unit (CU) and the second node is a distributed unit (DU).

In some embodiments, the collection request is transmitted using a signaling message associated with the terminal device.

In embodiments of the present disclosure, the collection request of the first measurement is transmitted using the signaling message associated with the terminal device. According to an embodiment, the first node is the CU-CP, the second node is the DU, and the collection request is included in a terminal device context setup request message, a terminal device context modification request message, a terminal device context modification confirmation message, an MDT collection request message or other F1 application proposal (F1AP) messages associated with the terminal device which are sent by the CU-CP to the DU. According to another embodiment, the first node is the CU-CP, the second node is the CU-UP, and the collection request of the first measurement is included in a bearer context setup request message, a bearer context modification request message, a bearer context modification confirmation message, an MDT collection request message or other E1 application proposal (E1AP) messages associated with the terminal device which are sent by the CU-CP to the CU-UP. According to yet another embodiment, the first node is the MN in a dual connectivity (DC) scenario, the second node is the SN in the DC scenario, and the collection request of the first measurement is included in an SN addition request message, an SN modification request message, a SN modification confirmation message, an MDT collection request message, a trace collection request message, a measurement collection request message or other Xn application proposal (XnAP) messages associated with the terminal device which are sent by the MN to the SN. It should be understood that the above is merely an example, and that the first node, the second node, and the message including the collection request of the first measurement are not limited thereto.

In some embodiments, the collection request is transmitted using a signaling message not associated with the terminal device.

In embodiments of the present disclosure, the collection request of the first measurement is transmitted using the signaling message not associated with the terminal device. According to an embodiment, the first node is the CU-CP, the second node is the DU, and information of the collection request of the first measurement is included in an F1 setup response message, a GNB-CU configuration update message, a collection request message of the first measurement or other F1AP messages not associated with the terminal device which are sent by the CU-CP to the DU. According to another embodiment, the first node is the CU-CP, the second node is the CU-UP, and the collection request of the first measurement is included in a GNB-CU-CP E1 setup request message, a GNB-CU-UP E1 setup response message, a GNB-CU-CP configuration update message, a collection request message of the first measurement or other E1AP messages not associated with the terminal device which are sent by the CU-CP to the CU-UP. According to yet another embodiment, the first node is the MN in the DC scenario, the second node is the SN in the DC scenario, and the collection request of the first measurement is included in an XN setup request message, an XN setup response message, an NG-RAN node configuration update message, an NG-RAN node configuration update acknowledge message, a collection request message of the first measurement, or other XnAP messages not associated with the terminal device which are sent by the MN to the SN. It should be understood that the above is merely an example, and that the first node, the second node, and the message including the collection request of the first measurement are not limited thereto.

In some embodiments, the first measurement includes at least one of:
management-based minimization of drive tests (MDT);
cell traffic trace; or
user equipment (UE) trace.

It may be understood that the MDT may be configured to collect measurement information of the terminal device and measurement information associated with the terminal device on an access network device side. The MDT is divided into a signaling-based MDT and a management-based MDT. In a case of the management-based MDT, MDT data is collected from a terminal device in a specified area, which is defined as a cell list or a trace/routing/location area list. The management-based MDT is an enhancement of a management-based trace function. In a case of the signaling-based MDT, the MDT data is collected from a specific terminal device. A terminal involved in collection of the MDT data is specified using an international mobile equipment identity (IMEI) or an IMEI software version, and the signaling-based MDT is an enhancement of a signaling-based trace function.

In the case of the management-based MDT, under a CU-DU separation architecture, the EM may send activated MDT configuration directly to the gNB-DU (hereafter referred to as the DU) or gNB-CU-CP (hereafter referred to as the CU-CP) or gNB-CU-UP (hereafter referred to as the CU-UP).

Referring to FIG. 4, FIG. 4 is a management-based MDT activation signaling flow in the gNB-DU (similar to the management-based MDT activation flow in the gNB-CU-UP).

In a case where the management-based MDT is activated in the gNB-DU (as shown in step 3), and the terminal device is selected to execute the MDT, and in a case where there is an anonymization parameter that is set to be an international mobile equipment identity-type allocation code (IMEI-TAC), the gNB-DU will send cell trace traffic to the gNB-CU-CP to inform the gNB-CU-CP of an trace ID of the selected terminal device (as shown in step 4), such that the gNB-CU-CP informs a core network (as shown in step 5). The core network then associates the terminal device ID with the trace ID and sends it to a TCE. Otherwise, the gNB-DU does not send any information about the MDT to the gNB-CU-CP. However, after collecting the MDT, the gNB-DU will send an MDT report, a cell traffic trace report or a terminal device trace report to the TCE, such that the TCE may perform further analysis on the measurement result. However, regarding the CU-CP, the whole process is unknown, that is, the CU-CP does not know start of the MDT measurement and specific measurement contents by the DU or the CU-UP (it should be noted that the fourth step in FIG. 4 may or may not occur, and even if it occurs, it is not known which type of measurement is performed). Therefore, in the related art it is not supported that the CU-CP obtains the measurement information and the measurement result of the MDT from the DU or the CU-UP.

In embodiments of the present disclosure, the first node (CU-CP) may send the collection request of the first measurement (MDT) to the second node (CU-UP), and may request to obtain the measurement information and the measurement result of the MDT.

In embodiments of the present disclosure, the first node (CU) may send the collection request of the first measurement (MDT) to the second node (DU), and may request to obtain the measurement information and the measurement result of the MDT.

Of course, in the related art, in a case where the management-based MDT is directly activated in the SN by the OAM, and the MN is not supported to obtain the measurement information and the measurement result of the MDT from the SN, in embodiments of the present disclosure, the first node (MN) may send the collection request of the first measurement (MDT) to the second node (SN), and may request to obtain the measurement information and the measurement result of the MDT.

Furthermore, in embodiments of the present disclosure, the first measurement may also be a cell traffic trace, in which the cell traffic trace is activated in the second node. The first node may send a collection request of the cell traffic trace to the second node, and may request to obtain measurement information and a measurement result of the cell traffic trace. The first node is the CU-CP and the second node is the CU-UP, or the first node is the CU and the second node is the DU, or the first node is the MN and the second node is the SN.

In embodiments of the present disclosure, the first measurement may also be a user equipment (UE) trace, in which the user equipment (UE) trace is activated in the second node. The first node may send a collection request of the user equipment (UE) trace to the second node, and may request to obtain measurement information and a measurement result of the user equipment (UE) trace. The first node is the CU-CP and the second node is the CU-UP, or the first node is the CU and the second node is the DU, or the first node is the MN and the second node is the SN.

In step S72, collection feedback of the first measurement sent by the second node is received, in which the first measurement is initiated and configured by the third node and activated on the second node, and the first node is different from the third node.

In embodiments of the present disclosure, the second node may send the collection feedback of the first measurement to the first node after receiving the collection request of the first measurement sent by the first node.

The first measurement is initiated and configured by the third node and activated on the second node, and the third node may be operation, administration and maintenance (OAM) or element manager (EM).

In some embodiments, the collection feedback includes a measurement report of the first measurement, and the measurement report includes at least one of:
a measurement identifier corresponding to the measurement result;
a terminal device identifier of a terminal device corresponding to the measurement result;
a measurement result;
a cell identifier of a specific cell corresponding to the measurement result;
a measurement start time corresponding to the measurement result; or
a measurement end time corresponding to the measurement result.

In embodiments of the present disclosure, the second node sends the collection feedback of the first measurement to the first node, in which the collection feedback includes one or more measurement results of the first measurement (or may also be referred to as a measurement report, e.g. an MDT report, a cell traffic trace report, or a user equipment trace report).

The measurement report includes the measurement identifier corresponding to the measurement result configured to indicate a first measurement ID, for example, a trace ID, corresponding to the measurement result in the measurement report.

The measurement report includes the terminal device identifier of the terminal device corresponding to the measurement result configured to indicate the terminal device corresponding to the measurement result in the measurement report, for example, a terminal device F1AP ID, a terminal device E1AP ID, a terminal device XNAP ID or the C-RNTI and other IDs identifying the terminal device in the radio access network.

The measurement report includes the measurement result, for example, the MDT report, the cell traffic trace report or the user equipment trace report, and the measurement result may include measurement results of one or more measurement contents and/or a time when the measurement report is generated.

The measurement report includes the cell identifier of the specific cell corresponding to the measurement result configured to indicate which cell the first measurement is fed back from, which may be the PCI or the CGI, for example.

The measurement report includes the measurement start time corresponding to the measurement result and/or the measurement end time corresponding to the measurement result configured to indicate a start time and/or an end time of the corresponding measurement in the measurement result of the first measurement, which may for example be in a form of a time stamp. The first node may analyze overall data collection by correlating measurement information from other nodes through a specific measurement time.

In some embodiments, the collection feedback is transmitted using the signaling message associated with the terminal device.

In some embodiments, the collection feedback is transmitted using the signaling message not associated with the terminal device.

In embodiments of the present disclosure, the collection feedback of the first measurement is transmitted using the signaling message associated with the terminal device or the signaling message not associated with the terminal device. According to an embodiment, the first node is the CU-CP, the second node is the DU, and the collection feedback of the first measurement is included in a collection feedback message of the first measurement, the MDT report, the cell traffic trace report or the user equipment trace report or other F1AP messages which are sent by the DU to the CU-CP. According to another embodiment, the first node is the CU-CP, the second node is the CU-UP, and the collection feedback of the first measurement is included in the collection feedback message of the first measurement, the MDT report, the cell traffic trace report or the user equipment trace report or other E1AP messages which are sent by the CU-UP to the CU-CP. According to yet another embodiment, the first node is the MN in the DC scenario, the second node is the SN in the DC scenario, and the collection feedback of the first measurement is included in the collection feedback message of the first measurement, the MDT report, the cell traffic trace report or the user equipment trace report or other XnAP messages which are sent by the MN to the SN. It should be understood that the above is merely an example, and that the first node, the second node, and the message including the collection feedback are not limited thereto.

In TR 37.817, under the CU-DU separation architecture, training and reasoning of an AI model are performed in the gNB-CU. In the DC scenario, the training and reasoning of the AI model are performed in the MN, and the measurement information associated with the terminal device will be used as input of the training and reasoning of the AI model or performance feedback of the AI model. The measurement information associated with the terminal device may be implemented by using the MDT measurement in the related art.

In a case where the training and reasoning of the AI model are in the CU-CP or the MN, according to a trace/MDT mechanism in the related art, and the managed trace/MDT is activated in the DU or the CU-UP or in the SN, the DU or the CU-UP or the SN starts measurement after selecting the terminal device, and directly sends the MDT report, the cell traffic trace report or the user equipment trace report to the OAM (e.g., the TCE in the OAM). The CU-CP is unaware of this process, that is, the CU-CP does not know start of the MDT measurement and the specific measurement content by the DU or the CU-UP (for example, the fourth step in FIG. 4 may or may not occur, and even if it occurs, it is not known which type of measurement is performed). Therefore, the trace/MDT mechanism does not support the CU-CP to obtain the measurement information and the measurement result of the trace/MDT from the DU or the CU-UP, and the existing trace/MDT mechanism also does not support the MN to obtain the measurement information and the measurement result of the trace/MDT from the SN.

Based on this, in embodiments of the present disclosure, in a case where the management-based MDT is activated on the second node, the first node, as the node responsible for the training or reasoning of the AI model, needs to collect an MDT measurement report from the second node. By means of the method provided in embodiments of the present disclosure, the second node may be enabled to select the terminal device to perform the MDT measurement in the targeted manner considering that the first node has a requirement of AI collection, and the first node may also be enabled to obtain detailed information of the MDT activated on the second node in time, for example, whether it is configured or activated, and information of the specific configured or activated MDT measurement content, and/or the MDT measurement report needing to be collected, such that MDT measurement data may be selected and collected in a targeted manner for AI-related operations.

In the CU-DU separation architecture, the first node is the CU or the CU-CP, and the second node is the DU or the CU-UP. In the dual connectivity scenario, the first node is the MN, and the second node is the SN.

In some embodiments, according to the collection feedback, the first node performs at least one of:
model training;
model reasoning; or
model performance feedback.

In embodiments of the present disclosure, the first node receives the collection feedback. In some embodiments, the first node uses the collection feedback as input for the model training, model reasoning, and/or model performance feedback to enable the model training, the model reasoning and the like more accurate. The model may be the artificial intelligence (AI) model, thereby enabling the access network device to make better load balancing, network energy saving and/or mobility optimization decisions, improving user experience, and reducing network energy consumption.

By implementing embodiments of the present disclosure, under the CU-DU or CP-UP separation architecture or the dual connectivity scenario, a node performing the training or reasoning and/or performance feedback of the AI model may be enabled to obtain information about whether the terminal device measurement is available on other nodes and/or collect the measurement information of the terminal device on other nodes, and the method may enable data collection of the training or reasoning and/or the performance feedback of the AI model to be diverse, flexible and targeted, thereby enabling the training and/or reasoning of the AI model to be more accurate. A better network optimization scheme may be implemented through a more accurate AI model, for example, load balancing, network energy saving, mobility optimization and the like, which may not only ensure or improve the user experience, improve the user loyalty and thus improve the operating revenue, but also save the network energy consumption and reduce the cost of operators.

By implementing embodiments of the present disclosure, the first node sends the collection request of the first measurement to the second node, and receives the collection feedback of the first measurement sent by the second node, in which the first measurement is initiated and configured by the third node and activated on the second node, and the first node is different from the third node. Therefore, the first node may obtain information of the first measurement activated in the second node, and the measurement result of the first measurement.

It may be understood that, in the CU-DU separation architecture, the first node is the CU, the second node is the DU, the trace is configured to the DU by the OAM through the CU, and the CU may know a measurement content about the trace (the cell traffic trace and/or the user equipment trace) in the DU. In this case, the CU may directly send the collection request of the measurement of the trace to the DU, and then receive the collection feedback sent by the DU to obtain the measurement information and/or the measurement result of the trace.

In a case where the first node is the CU, the second node is the DU, and the first measurement is the management-based MDT, the second node may send availability information of the first measurement configured to determine the collection request to the first node in advance, such that the first node may obtain the availability information of the first measurement, then select a specific terminal device and/or a specific measurement content in the targeted manner to collect the measurement result, and send the collection request to the second node.

Furthermore, for the first case: the first node is the CU-CP, the second node is the CU-UP, and the first measurement is the management-based MDT; for the second case: the first node is the CU-CP, the second node is the CU-UP, and the first measurement is the trace (the cell traffic trace and/or the user equipment (UE) trace); for the third case: the first node is the MN, the second node is the SN, and the first measurement is the management-based MDT; for the fourth case: the first node is the MN, the second node is the SN, and the first measurement is the trace (the cell traffic trace and/or the user equipment (UE) trace). The second node may send the availability information of the first measurement configured to determine the collection request to the first node in advance, such that the first node may obtain the availability information of the first measurement, and then select the specific terminal device and/or the specific measurement content in the targeted manner to collect the measurement result, and send the collection request to the second node.

In some embodiments, the second node sends the availability information of the first measurement configured to determine the collection request to the first node.

It may be understood that, before receiving the collection request of the first measurement sent by the first node, the second node may send the availability information of the first measurement to the first node to indicate the availability information of the first measurement that may be obtained. Therefore, the first node may determine the collection request sent to the second node according to the availability information.

In some embodiments, the availability information includes at least one of:
a start indication of the first measurement being activated;
a stop indication of the first measurement being activated;
a cell identifier of a specific cell corresponding to information fed back by the first measurement being activated;
a measurement identifier of the first measurement being activated;
a terminal device identifier of the terminal device for which the first measurement is activated; or
content information of the first measurement being activated.

The start indication of the first measurement being activated or the stop indication of the first measurement being activated is configured to indicate a specific status of the first measurement, such as a start or stop indication.

The cell identifier of the specific cell corresponding to the information fed back by the first measurement being activated is configured to indicate which specific cell the feedback information belongs to, which may be the PCI or the CGI, for example.

The measurement identifier of the first measurement being activated is configured to indicate the ID of the first measurement, for example, the trace ID, trace reference, or trace session recording reference and the like.

The terminal device identifier of the terminal device for which the first measurement is activated is configured to indicate the terminal device for which the first measurement is activated. For example, it may be the terminal device F1AP ID, the terminal device E1AP ID, the terminal device XNAP ID or C-RNTI and other IDs identifying the terminal device in the radio access network.

The content information of the first measurement being activated is configured to indicate the content for which the first measurement is activated. According to an embodiment, the measurement content of the first measurement being activated may be the bitmap, in which each bit represents a measurement content, for example, a value of “1” represents that the content information of the first measurement being activated is activated, and a value of “0” represents that the content information of the first measurement being activated is not activated. The content information of the first measurement being activated may include, but is not limited to, the M2 (power headroom), the M5 (UE average throughput), the M6 (packet latency), the M7 (packet loss rate), the channel quality indictor, the power headroom report, the uplink interference and the like of the MDT.

In some embodiments, information included in the availability information of the first measurement may be a list of information, each list including one or more of the above information.

The AI-related operations may be the training of the AI model, the reasoning of the AI model and/or the performance feedback of the AI model and the like.

In some embodiments, the availability information is transmitted using the signaling message associated with the terminal device.

In embodiments of the present disclosure, the availability information of the first measurement is transmitted using the signaling message associated with the terminal device. According to an embodiment, the first node is the CU-CP, the second node is the DU, and the availability information of the first measurement is included in a terminal device context setup feedback message, a terminal device context modification feedback message, a terminal device context modification requirement message, an MDT availability feedback message, a cell service trace message or other F1AP messages associated with the terminal device which are sent by the DU to the CU-CP. According to another embodiment, the first node is the CU-CP, the second node is the CU-UP, and the availability information of the first measurement is included in a bearer context setup feedback message, a bearer context modification feedback message, a bearer context modification requirement message, a cell service trace message or other E1AP messages associated with the terminal device which are sent by the CU-UP to the CU-CP. According to yet another embodiment, the first node is the MN in the DC scenario, the second node is the SN in the DC scenario, and the availability information of the first measurement is included in an SN addition request confirmation message, an SN modification confirmation message, an SN modification requirement, a cell service trace message or other XnAP messages associated with the terminal device which are sent by the MN to the SN. It should be understood that the above is merely an example, and that the first node, the second node, and the message including the availability information of the first measurement are not limited thereto.

In some embodiments, the availability information is transmitted using the signaling message not associated with the terminal device.

In some embodiments, the availability information of the first measurement is transmitted using the signaling message not associated with the terminal device. According to an embodiment, the first node is the CU-CP, the second node is the DU, and information of the availability information of the first measurement is included in an F1 setup request message, a GNB-CU configuration update message, an availability information message of the first measurement or other F1AP messages not associated with the terminal device which are sent by the DU to the CU-CP. According to another embodiment, the first node is the CU-CP, the second node is the CU-UP, and the availability information of the first measurement is included in a GNB-CU-UP E1 setup request message, a GNB-CU-CP E1 setup response message, a GNB-CU-UP configuration update message, a collection request message of the first measurement or other E1AP messages not associated with the terminal device which are sent by the CU-UP to the CU-CP. According to yet another embodiment, the first node is the MN in the DC scenario, the second node is the SN in the DC scenario, and the availability information of the first measurement is included in an XN setup request message, an XN setup response message, an NG-RAN node configuration update message, an NG-RAN node configuration update acknowledge message, a collection request message of the first measurement or other XnAP messages not associated with the terminal device which are sent by the MN to the SN. It should be understood that the above is merely an example, and that the first node, the second node, and the message including the availability information of the first measurement are not limited thereto.

In embodiments of the present disclosure, the first node receives the availability information and may select the content of the first measurement needing to be collected according to the availability information and/or its own collection requirement. The second node sends the availability information to the first node. The first node may consider the availability information and select a specific terminal device and/or a specific measurement content in the targeted manner to collect the measurement result for the AI-related operations, thereby avoiding unnecessary measurement information collection and additional signaling overhead.

In a case where the first node is the CU, the second node is the DU, and the first measurement is the management-based MDT, the second node may send the availability information of the first measurement configured to determine the collection request to the first node in advance, such that the first node may obtain the availability information of the first measurement, then select the specific terminal device and/or the specific measurement content in the targeted manner to collect the measurement result, and send the collection request to the second node. Moreover, the second node may send the availability information to the first node in response to an availability request of the first node.

Furthermore, for the first case: the first node is the CU-CP, the second node is the CU-UP, and the first measurement is the management-based MDT; for the second case: the first node is the CU-CP, the second node is the CU-UP, and the first measurement is the trace (the cell traffic trace and/or the user equipment (UE) trace); for the third case: the first node is the MN, the second node is the SN, and the first measurement is the management-based MDT; for the fourth case: the first node is the MN, the second node is the SN, the first measurement is the trace (the cell traffic trace and/or the user equipment (UE) trace). The second node may send the availability information of the first measurement configured to determine the collection request to the first node in advance, such that the first node may obtain the availability information of the first measurement, and then select the specific terminal device and/or specific measurement content in the targeted manner to collect the measurement result, and send the collection request to the second node. Moreover, the second node may send the availability information to the first node in response to the availability request of the first node.

In some embodiments, the second node receives the availability request of the first measurement sent by the first node, in which the availability request is configured to indicate the second node to obtain the availability information and send the availability information to the first node.

In embodiments of the present disclosure, the first node sends the availability request of the first measurement to the second node, in which the availability request is configured to indicate the second node to obtain the availability information and feed it back to the first node.

In some embodiments, the availability request includes at least one of:
information indicating measurement availability information;
indicating that the first node has an artificial intelligence (AI) function;
indicating that the artificial intelligence (AI) function of the first node is turned on;
indicating that the artificial intelligence (AI) function of the first node is turned off; or
a feedback condition of measurement availability information.

The availability request may include a first indication configured to request the availability information, indicate that the first node needs to collect the first measurement, indicate that the first node has the AI function (for example, the training of the AI model and the reasoning of the AI model), and indicate that the AI function of the first node is turned on, or indicate that the AI function of the first node is turned off.

According to an embodiment, display information of the first indication is true, that is, which means that the first node needs to collect the availability information of the first measurement of the terminal device. In a case where the first indication is present, the second node receives and stores the first indication. According to an embodiment, in a case where a second measurement of the terminal device is not activated, and the second node receives an activation request of the first measurement from the third node, the second node may consider the first indication to decide whether to select the terminal device to perform the first measurement, and/or the second node sends the availability information of the first measurement to the first node. According to another embodiment, the second node sends the availability information of the first measurement to the first node in a case where the first measurement of the terminal device has been activated. It should be understood that the above is merely an example, and the operations performed by the second node considering the first indication are not limited thereto. The third node may be an OAM or an EM.

The availability request includes the feedback condition of the measurement availability information configured to indicate a condition for requesting the availability information of the first measurement, and the second node needs to feed back the requested information only in a case where the condition is satisfied. According to an embodiment, the feedback condition may be a specific measurement content, for example, the M2 (power headroom), the M5 (UE average throughput), the M6 (packet latency), the M7 (packet loss rate), the channel quality indictor, the power headroom report, the uplink interference and the like in the MDT. In a case where the second node is configured with the same measurement content, the second node needs to feed back information of the configured first measurement and/or a result of the first measurement to the first node. According to another embodiment, the feedback condition may be cell information, network slice, the terminal device ID and other information, indicating that the first node only requests the availability information of the first measurement corresponding to the cell, network slice, and/or specific terminal device.

In some embodiments, the availability request is transmitted using the signaling message associated with the terminal device.

In embodiments of the present disclosure, the availability request of the first measurement is transmitted using the signaling message associated with the terminal device. According to an embodiment, the first node is the CU-CP, the second node is the DU, and the availability request of the first measurement is included in a terminal device context setup request message, a terminal device context modification request message, a terminal device context modification confirmation message or other F1AP messages associated with the terminal device which are sent by the CU-CP to the DU. According to another embodiment, the first node is the CU-CP, the second node is the CU-UP, and the availability request of the first measurement is included in a bearer context setup request message, a bearer context modification request message, a bearer context modification confirmation message or other E1AP messages associated with the terminal device which are sent by the CU-CP to the CU-UP. According to yet another embodiment, the first node is the MN in the DC scenario, the second node is the SN in the DC scenario, and the availability request of the first measurement is included in an SN addition request message, an SN modification request message, an SN modification confirmation message or other XnAP messages associated with the terminal device which are sent by the MN to the SN. It should be understood that the above is merely an example, and that the first node, the second node, and the message including the availability request of the first measurement are not limited thereto. The first measurement may be MDT measurement, but is not limited thereto.

In some embodiments, the availability request is transmitted using the signaling message not associated with the terminal device.

In embodiments of the present disclosure, the availability request of the first measurement is transmitted using the signaling message not associated with the terminal device. According to an embodiment, the first node is the CU-CP, the second node is the DU, and information of the availability request of the first measurement is included in an F1 setup response message, a GNB-CU configuration update message, a collection request message of the first measurement or other F1AP messages not associated with the terminal device which are sent by the CU-CP to the DU. According to another embodiment, the first node is the CU-CP, the second node is the CU-UP, and the availability request of the first measurement is included in a GNB-CU-CP E1 setup request message, a GNB-CU-UP E1 setup response message, a GNB-CU-CP configuration update message, a collection request message of the first measurement or other E1AP messages not associated with the terminal device which are sent by the CU-CP to the CU-UP. According to yet another embodiment, the first node is the MN in the DC scenario, the second node is the SN in the DC scenario, and the availability request of the first measurement is included in an XN setup request message, an XN setup response message, an NG-RAN node configuration update message, an NG-RAN node configuration update acknowledge message, the collection request message of the first measurement or other XnAP messages not associated with the terminal device which are sent by the MN to the SN. It should be understood that the above is merely an example, and that the first node, the second node, and the message including the availability of the first measurement are not limited thereto.

In embodiments of the present disclosure, the second node receives and stores the availability request of the first measurement, and sends the availability information of the first measurement to the first node according to an activation situation of the first measurement. The first node sends the availability request of the first measurement to the second node. The second node may consider the availability request and select the terminal device or a terminal device under a specific condition in the targeted manner to perform the first measurement. Moreover, once the first measurement is activated, the second node may report to the first node more promptly such that the first node decides how to collect the content of the measurement report of the first measurement for the AI-related operation.

In embodiments of the present disclosure, the second node sends the availability information to the first node in response to the availability request of the first measurement sent by the first node. Alternatively, the second node sends the availability information to the first node according to configuration of the second node itself (for example, configured through the OAM or according to a protocol agreement).

It may be understood that the second node sends the availability information of the first measurement to the first node in a case where the first measurement has been activated on the second node. Therefore, the first node may select the specific terminal device and/or the specific measurement content in the more targeted manner to collect the measurement result according to the availability information for the AI-related operation, thereby avoiding unnecessary measurement information collection and additional signaling overhead.

In embodiments of the present disclosure, the first node sends the availability request of the first measurement to the second node, which may be sent before the first measurement is activated on the second node, or may also be sent after the first measurement is activated on the second node. That is, in one case: the third node initiates the configuration to the second node, the first measurement is activated on the second node, and then the first node sends the availability request of the first measurement to the second node. In another case, the first node sends the availability request of the first measurement to the second node. Since the first measurement is not activated at this time, the second node does not send the availability information of the first measurement to the first node. In a case of receiving the configuration for activating the first measurement sent by the third node, the second node decides whether to select the terminal device to perform the first measurement according to the availability request of the first measurement. For example, in a case where the availability request includes the signaling message associated with the terminal device for transmission, the terminal device is selected to perform the first measurement, and then the relevant information of the first measurement is obtained, and the availability information of the first measurement is sent to the first node.

Referring to FIG. 8, FIG. 8 is a flow chart illustrating yet another method for obtaining measurement provided by an embodiment of the present disclosure.

As shown in FIG. 8, the method is performed by a first node. The method may include but is not limited to the following steps.

In step S81, availability information of a first measurement configured to determine a collection request sent by a second node is received.

It may be understood that, before receiving the collection request of the first measurement sent by the first node, the second node may send the availability information of the first measurement to the first node to indicate the availability information of the first measurement that may be obtained. Therefore, the first node may determine the collection request sent to the second node according to the availability information.

In some embodiments, the availability information includes at least one of:
a start indication of the first measurement being activated;
a stop indication of the first measurement being activated;
a cell identifier of a specific cell corresponding to information fed back by the first measurement being activated;
a measurement identifier of the first measurement being activated;
a terminal device identifier of the terminal device for which the first measurement is activated; or
content information of the first measurement being activated.

The relevant description of the availability information may refer to the relevant description in above embodiments, and will not be described again here.

In some embodiments, the availability information is transmitted using a signaling message associated with the terminal device.

In some embodiments, the availability information is transmitted using a signaling message not associated with the terminal device.

The relevant description of transmission manner of the availability information may refer to the relevant description in above embodiments, and will not be described again here.

In embodiments of the present disclosure, the first node receives the availability information and may select the content of the first measurement needing to be collected according to the availability information and/or its own collection requirement. The second node sends the availability information to the first node. The first node may consider the availability information and select a specific terminal device and/or a specific measurement content in the more targeted manner to collect the measurement result for the AI-related operations, thereby avoiding unnecessary measurement information collection and additional signaling overhead.

In step S82, the collection request of the first measurement is sent to the second.

In step S83, collection feedback of the first measurement sent by the second node is received, in which the first measurement is initiated and configured by a third node and activated on the second node, and the first node is different from the third node.

In embodiments of the present disclosure, the relevant descriptions of S82 and S83 may refer to the relevant descriptions in above embodiments, and will not be described again here.

By implementing embodiments of the present disclosure, the first node receives the availability information of the first measurement configured to determine the collection request sent by the second node; sends the collection request of the first measurement to the second node; and receives the collection feedback of the first measurement sent by the second node, in which the first measurement is initiated and configured by the third node and activated on the second node, and the first node is different from the third node. Therefore, the first node may obtain information of the first measurement activated in the second node and a measurement result of the first measurement.

Referring to FIG. 9, FIG. 9 is a flow chart illustrating yet another method for obtaining measurement provided by an embodiment of the present disclosure.

As shown in FIG. 9, the method is performed by a first node. The method may include but is not limited to the following steps.

In step S91, an availability request of a first measurement is sent to a second node, in which the availability request is configured to indicate the second node to obtain availability information, and send the availability information to the first node.

In embodiments of the present disclosure, the first node sends the availability request of the first measurement to the second node, in which the availability request is configured to indicate the second node to obtain the availability information and feed it back to the first node.

In some embodiments, the availability request includes at least one of:
information indicating measurement availability information;
indicating that the first node has an artificial intelligence (AI) function;
indicating that the artificial intelligence (AI) function of the first node is turned on;
indicating that the artificial intelligence (AI) function of the first node is turned off; or
a feedback condition of measurement availability information.

The relevant description of the availability request may refer to the relevant description in above embodiments, and will not be described again here.

In some embodiments, the availability request is transmitted using a signaling message associated with the terminal device.

In some embodiments, the availability request is transmitted using a signaling message not associated with the terminal device.

The relevant description of transmission manner of the availability request may refer to the relevant description in above embodiments, and will not be described again here.

In embodiments of the present disclosure, the second node receives and stores the availability request of the first measurement, and sends the availability information of the first measurement to the first node according to an activation situation of the first measurement.

The first node sends the availability request of the first measurement to the second node. The second node may consider the availability request and select the terminal device or a terminal device under a specific condition in the targeted manner to perform the first measurement. Moreover, once the first measurement is activated, the second node may report to the first node more promptly such that the first node decides how to collect the content of the measurement report of the first measurement for the AI-related operation.

In embodiments of the present disclosure, the second node sends the availability information to the first node in response to the availability request of the first measurement sent by the first node. Alternatively, the second node sends the availability information to the first node according to configuration of the second node itself (for example, configured through the OAM or according to a protocol agreement).

In step S92, the availability information of the first measurement configured to determine the collection request sent by the second node is received.

In step S93, the collection request of the first measurement is sent to the second node.

In step S94, collection feedback of the first measurement sent by the second node is received, in which the first measurement is initiated and configured by a third node and activated on the second node, and the first node is different from the third node.

In embodiments of the present disclosure, the relevant descriptions of S92 to S94 may refer to the relevant descriptions in above embodiments, and will not be described again here.

By implementing embodiments of the present disclosure, the first node sends the availability request of the first measurement to the second node, in which the availability request is configured to indicate the second node to obtain the availability information and send the availability information to the first node. The first node receives the availability information of the first measurement sent by the second node configured to determine the collection request. The first node sends the collection request of the first measurement to the second node. The first node receives the collection feedback of the first measurement sent by the second node, in which the first measurement is initiated and configured by the third node and activated on the second node, and the first node is different from the third node. Therefore, the first node may obtain information of the first measurement activated in the second node and a measurement result of the first measurement.

In above embodiments provided in the present disclosure, the method provided by embodiments of the present disclosure is introduced from the perspective of the first node and the second node, respectively. In order to implement the various functions in the method provided by above embodiments of the present disclosure, the first node and the second node may include a hardware structure and a software module to implement the above functions in the form of a hardware structure, a software module, or a hardware structure plus a software module. Any of the above functions may be implemented in the form of a hardware structure, a software module, or a hardware structure plus a software module.

Referring to FIG. 10, FIG. 10 is a structural diagram illustrating a communication device 1 provided by an embodiment of the present disclosure. The communication device 1 shown in FIG. 10 may include a transceiver module 11 and a processing module 12. The transceiver module may include a sending module and/or a receiving module. The sending module is configured to implement a sending function, and the receiving module is configured to implement a receiving function. The transceiver module may implement a sending function and/or a receiving function.

The communication device 1 is a second node:

the communication device 1 includes: a transceiver module 11.

The transceiver module 11 is configured to receive a collection request of a first measurement sent by a first node.

The transceiver module 11 is further configured to send collection feedback of the first measurement to the first node, in which the first measurement is initiated and configured by a third node and activated on a second node, and the first node is different from the third node.

In some embodiments, the first measurement includes at least one of:
management-based minimization of drive tests (MDT);
cell traffic trace; or
user equipment (UE) trace.

In some embodiments, the collection request includes at least one of:
a start collection indication;
a stop collection indication;
time information for collection;
a cell identifier of a specific cell needing to be collected;
a measurement identifier of the first measurement needing to be collected;
a terminal device identifier of a terminal device needing to be collected;
measurement content of the first measurement needing to be collected; or
a reporting manner of a measurement report.

In some embodiments, the collection feedback includes a measurement report of the first measurement, and the measurement report includes at least one of:
a measurement identifier corresponding to a measurement result;
a terminal device identifier of a terminal device corresponding to a measurement result;
a measurement result;
a cell identifier of a specific cell corresponding to a measurement result;
a measurement start time corresponding to a measurement result; or
a measurement end time corresponding to a measurement result.

In some embodiments, the transceiver module 11 is further configured to send availability information of the first measurement configured to determine the collection request to the first node.

In some embodiments, the availability information includes at least one of:
a start indication of the first measurement being activated;
a stop indication of the first measurement being activated;
a cell identifier of a specific cell corresponding to information fed back by the first measurement being activated;
a measurement identifier of the first measurement being activated;
a terminal device identifier of the terminal device for which the first measurement is activated; or
content information of the first measurement being activated.

In some embodiments, the availability request of the first measurement sent by the first node is received, in which the availability request is configured to indicate the second node to obtain the availability information, and send the availability information to the first node.

In some embodiments, the availability request includes at least one of:
information indicating measurement availability information;
indicating that the first node has an artificial intelligence (AI) function;
indicating that the artificial intelligence (AI) function of the first node is turned on;
indicating that the artificial intelligence (AI) function of the first node is turned off; or
a feedback condition of measurement availability information.

In some embodiments, at least one of the collection request, the collection feedback, the availability information, and the availability request is transmitted using a signaling message associated with a terminal device.

In some embodiments, at least one of the collection request, the collection feedback, the availability information, and the availability request is transmitted using a signaling message not associated with a terminal device.

In some embodiments, the first node is a centralized unit-control plane (CU-CP) and the second node is a centralized unit-user plane (CU-UP).

In some embodiments, the first node is a master node (MN) and the second node is a secondary node (SN).

In some embodiments, the first node is a centralized unit (CU) and the second node is a distributed unit (DU).

The communication device 1 is a first node:
the communication device 1 includes: a transceiver module 11 and a processing module 12.

The transceiver module 11 is configured to receive a collection request of a first measurement sent by a first node.

The transceiver module 11 is further configured to send collection feedback of the first measurement to the first node, in which the first measurement is initiated and configured by a third node and activated on a second node, and the first node is different from the third node.

In some embodiments, the processing module 12 is configured to, according to the collection feedback, perform at least one of:
model training;
model reasoning; or
model performance feedback.

In some embodiments, the first measurement includes at least one of:
management-based minimization of drive tests (MDT);
cell traffic trace; or
user equipment (UE) trace.

In some embodiments, the collection request includes at least one of:
a start collection indication;
a stop collection indication;
time information for collection;
a cell identifier of a specific cell needing to be collected;
a measurement identifier of the first measurement needing to be collected;
a terminal device identifier of a terminal device needing to be collected;
measurement content of the first measurement needing to be collected; or
a reporting manner of a measurement report.

In some embodiments, the collection feedback includes a measurement report of the first measurement, and the measurement report includes at least one of:
a measurement identifier corresponding to a measurement result;
a terminal device identifier of a terminal device corresponding to a measurement result;
a measurement result;
a cell identifier of a specific cell corresponding to a measurement result;
a measurement start time corresponding to a measurement result; or
a measurement end time corresponding to a measurement result.

In some embodiments, the transceiver module 11 is further configured to receive availability information of the first measurement configured to determine the collection request sent by the second node.

In some embodiments, the availability information includes at least one of:
a start indication of the first measurement being activated;
a stop indication of the first measurement being activated;
a cell identifier of a specific cell corresponding to information fed back by the first measurement being activated;
a measurement identifier of the first measurement being activated;
a terminal device identifier of the terminal device for which the first measurement is activated; or
content information of the first measurement being activated.

In some embodiments, the transceiver module 11 is further configured to send an availability request of the first measurement to the second node, in which the availability request is configured to indicate the second node to obtain the availability information, and send the availability information to the first node.

In some embodiments, the availability request includes at least one of:
information indicating measurement availability information;
indicating that the first node has an artificial intelligence (AI) function;
indicating that the artificial intelligence (AI) function of the first node is turned on;
indicating that the artificial intelligence (AI) function of the first node is turned off; or
a feedback condition of measurement availability information.

In some embodiments, at least one of the collection request, the collection feedback, the availability information, and the availability request is transmitted using a signaling message associated with a terminal device.

In some embodiments, at least one of the collection request, the collection feedback, the availability information, and the availability request is transmitted using a signaling message not associated with a terminal device.

In some embodiments, the first node is a centralized unit-control plane (CU-CP) and the second node is a centralized unit-user plane (CU-UP).

In some embodiments, the first node is a master node (MN) and the second node is a secondary node (SN).

In some embodiments, the first node is a centralized unit (CU) and the second node is a distributed unit (DU).

Regarding the communication device 1 in above embodiments, the specific manner in which the respective modules perform operations has been described in detail in embodiments of the method, and will not be described in detail herein.

The communication device 1 provided in above embodiments of the present disclosure achieves the same or similar advantageous effects as the method for obtaining measurement provided in some of above embodiments, and will not be described in detail herein.

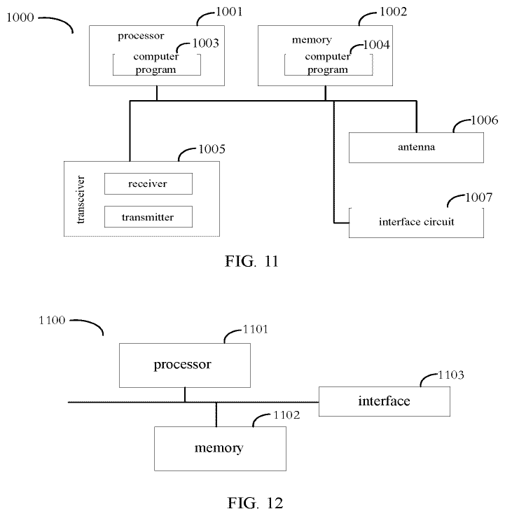

Referring to FIG. 11, FIG. 11 is a structural diagram illustrating another communication device 1000 provided by an embodiment of the present disclosure. The communication device 1000 may be a first node; a second node; a chip, a chip system or a processor supporting the first node to implement the above-mentioned method; and a chip, a chip system or a processor supporting the second node to implement the above-mentioned method. The communication device 1000 may be configured to implement the method as described in method embodiments described above, with particular reference to the description of method embodiments described above.

The communication device 1000 may include one or more processors 1001. The processor 1001 may be a general-purpose processor or a special-purpose processor, etc. It may be, for example, a baseband processor or a central processor. The baseband processor may be configured to process a communication protocol and communication data, and the central processor may be configured to control a communication device (such as a first node, a second node, a baseband chip, a terminal device, a terminal device chip, a DU or a CU, etc.), execute a computer program and process data of the computer program.

Optionally, the communication device 1000 may further include one or more memories 1002 on which the computer program 1004 may be stored, and the memory 1002 executes the computer program 1004 to cause the communication device 1000 to perform the method as described in above method embodiments. Optionally, the memory 1002 may also have the data stored therein. The communication device 1000 and the memory 1002 may be provided independently or integrated together.

Optionally, the communication device 1000 may further include a transceiver 1005 and an antenna 1006. The transceiver 1005 may be referred to as a transceiving unit, a transceiving machine, or a transceiving circuit or the like for implementing a transceiving function. The transceiver 1005 may include a receiver and a transmitter, and the receiver may be referred to as a receiving machine or a receiving circuit or the like for implementing a receiving function; the transmitter may be referred to as a transmitting machine or a transmission circuit or the like for implementing a transmitting function.

Optionally, the communication device 1000 may further include one or more interface circuits 1007. The interface circuit 1007 is configured to receive and transmit the code instructions to the processor 1001. The processor 1001 executes the code instructions to cause the communication device 1000 to perform the method described in above method embodiments.

The communication device 1000 is a second node: the transceiver 1005 is configured to execute S31 and S32 in FIGS. 3; S51 to S53 in FIGS. 5; S61 to S64 in FIG. 6.

The communication device 1000 is a first node: the transceiver 1005 is configured to execute S71 and S72 in FIGS. 7; S81 to S83 in FIGS. 8; S91 to S94 in FIG. 9.

In one implementation, the processor 1001 may further include the transceiver for implementing receiving and transmitting functions. For example, the transceiver may be a transceiving circuit, or an interface, or an interface circuit. The transceiving circuit, interface, or interface circuit for implementing the receiving and transmitting functions may be separate or integrated. The transceiving circuit, interface or interface circuit may be configured to read and write code/data, or the transceiving circuit, interface or interface circuit may be configured for transmission or transfer of signal.

In one implementation, the processor 1001 may store the computer program 1003 that, when run on the processor 1001, causes the communication device 1000 to perform the method described in above method embodiments. The computer program 1003 may be solidified in the processor 1001, in which case the processor 1001 may be implemented in hardware.

In one implementation, the communication device 1000 may include a circuit that may implement the functions of transmitting or receiving or communication in foregoing method embodiments. The processor and transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device, etc. The processor and transceiver may also be fabricated with various IC process technologies such as complementary metal oxide semiconductor (CMOS), n-metal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication device in above embodiments may be the first node or the second node, but the scope of the communication device described in the present disclosure is not limited thereto. Moreover, the structure of the communication device may not be limited by FIG. 11. The communication device may be a stand-alone device or may be a part of a larger device. For example, the communication device may be:
(1) a stand-alone integrated circuit (IC), or a chip, or a chip system or a subsystem;
(2) a collection of one or more ICs, optionally the collection of ICs may also include a storage component for storing the data and the computer program;
(3) ASIC such as modem;
(4) a module that may be embedded in other devices;
(5) a receiver, a terminal device, an intelligent terminal device, a cellular phone, a wireless device, a handset, a mobile unit, an on-vehicle device, a network device, a cloud device, an artificial intelligence device, etc.; or
(6) others.

In a case where the communication device may be the chip or the chip system, reference is made to FIG. 12, which is a structural diagram of the chip provided by an embodiment of the present disclosure.

The chip 1100 includes a processor 1101 and an interface 1103. There may be one or more processors 1101 and a plurality of interfaces 1103.

Regarding a case where the chip is configured to implement the functions of the first node in embodiments of the present disclosure:

The interface 1103 is configured to receive code instructions and transmit the code instructions to the processor.

The processor 1101 is configured to execute the code instructions to perform a method for obtaining measurement as described in some embodiments above.

Regarding a case where the chip is configured to implement the functions of the second node in embodiments of the present disclosure:

The interface 1103 is configured to receive code instructions and transmit the code instructions to the processor.

The processor 1101 is configured to execute the code instructions to perform a method for obtaining measurement as described in some embodiments above.

Optionally, the chip 1100 further includes the memory 1102 for storing necessary computer programs and data.

Those skilled in the art may further appreciate that the various illustrative logical blocks and steps described in embodiments of the present disclosure may be implemented in electronic hardware, computer software, or combinations of both. Whether such functionality is implemented as hardware or software depends upon particular application and design requirement of the overall system. Those skilled in the art may implement the described functionality in varying ways for each particular application, but such implementation should not be considered to be beyond the scope of protection of embodiments of the present disclosure.

Embodiments of the present disclosure further provides a system for obtaining measurement which includes the communication device as a first node and the communication device as a second node in forgoing embodiment of FIG. 10, or which includes the communication device as a first node and the communication device as a second node in forgoing embodiment of FIG. 11.

The present disclosure further provides a readable storage medium having instructions stored thereon that, when executed by the computer, causes the functions of any of the method embodiments described above to be implemented.

The present disclosure also provides a computer program product that, when executed by the computer, causes the functions of any of the method embodiments described above to be implemented.

In above embodiments, the present disclosure may be implemented in whole or in part by the hardware, software, firmware or their combination. When implemented in the software, the present disclosure may be implemented in whole or in part as the computer program product. The computer program product includes one or more computer programs. The computer programs, when loaded and executed on the computer, result in whole or in part in processes or functions according to embodiments of the present disclosure. The computer may be a general-purpose computer, a special-purpose computer, a computer network, or other programmable devices. The computer program may be stored in a computer-readable storage medium or transmitted from one computer-readable storage medium to another, for example, the computer program may be transmitted from one website, computer, server, or data center to another website, computer, server, or data center by wire (e.g. coaxial cable, fiber optic, digital subscriber line (DSL)) or wirelessly (e.g. infrared, wireless, microwave, etc.). The computer-readable storage medium may be any available medium that may be accessed by the computer or a data storage device, such as a server, a data center, etc., that includes one or more available media. The available medium may be a magnetic medium (e.g. a floppy disk, a hard disk, a magnetic tape), an optical medium (e.g. a high-density digital video disc (DVD)), or a semiconductor medium (e.g. a solid state disk (SSD)), etc.

Those skilled in the art may appreciate that the first, second, and other numerical numbers involved in the present disclosure are merely for convenience of description and are not intended to limit the scope of embodiments of the present disclosure, which also represent a sequential order.

Term “at least one” in the present disclosure may also be described as one or more, and “a plurality of” may be two, three, four, or more, and the present disclosure is not limited thereto. In embodiments of the present disclosure, regarding a type of technical features, the technical features in the type of technical features are distinguished by “first”, “second”, “third”, “A”, “B”, “C” and “D”, etc. and there is no order of precedence or order of magnitude between the technical features described by the “first”, “second”, “third”, “A”, “B”, “C” and

Correspondence shown in tables in the present disclosure may be configured or predefined. Values of information in each table are merely examples, and may be configured as other values, which is not limited in the present disclosure. In a case of configuring the correspondence between the configuration information and each parameter, it is not necessarily required that all the correspondences shown in each table must be configured. For example, the correspondence shown in certain rows in the tables in the present disclosure may not be configured. As another example, appropriate deformation adjustments may be made based on the above table, such as splitting, merging, etc. Names of the parameters shown in titles of the above tables may also be other names understandable by the communication device, and the values or expressions of the parameters may also be other values or expressions understandable by the communication device. The above-mentioned tables may also be implemented using other data structures, for example, an array, a queue, a container, a stack, a linear table, a pointer, a linked list, a tree, a graph, a struct, a class, a heap, or a hash table.

“Predefined” in the present disclosure may be understood as defined, pre-defined, stored, pre-stored, pre-negotiated, pre-configured, solidified, or pre-fired.

Those skilled in the art may appreciate that units and algorithm steps of each example described in conjunction with embodiments disclosed herein may be implemented with the electronic hardware, or combinations of the computer software and the electronic hardware. Whether such functionality is implemented in hardware or software depends on the specific application and design constraints of the technical solution. Those skilled in the art may implement the described functionality in varying ways for each particular application, but such implementation should not be considered to be beyond the scope of the present disclosure.

It will be clear to those skilled in the art that, for convenience and brevity of the description, specific working procedures of the above described systems, devices and units may refer to corresponding procedures in the preceding method embodiments and will not be described in detail here.

The above description is only for the specific embodiments of the present disclosure, but the scope of the present disclosure is not limited thereto. Any person skilled in the art may easily think of changes or substitutions within the technical scope of the present disclosure, which shall be covered by the protection scope of the present disclosure. Therefore, the protection scope of the present application shall be in line with the attached claims.

1. A method for obtaining measurement, performed by a second node, comprising:
receiving a collection request of a first measurement sent by a first node; and
sending collection feedback of the first measurement to the first node, wherein the first measurement is initiated and configured by a third node and activated on the second node, and the first node is different from the third node.

2. The method according to claim 1, wherein the first measurement comprises at least one of:
management-based minimization of drive tests (MDT);
cell traffic trace; or
user equipment (UE) trace.

3. The method according to claim 1, wherein the collection request comprises at least one of:
a start collection indication;
a stop collection indication;
time information for collection;
a cell identifier of a specific cell needing to be collected;
a measurement identifier of the first measurement needing to be collected;
a terminal device identifier of a terminal device needing to be collected;
measurement content of the first measurement needing to be collected; or
a reporting manner of a measurement report; or
wherein the collection feedback comprises a measurement report of the first measurement, and the measurement report comprises at least one of:
a measurement identifier corresponding to a measurement result;
a terminal device identifier of a terminal device corresponding to a measurement result;
a measurement result;
a cell identifier of a specific cell corresponding to a measurement result;
a measurement start time corresponding to a measurement result; or
a measurement end time corresponding to a measurement result.

4. (canceled)

5. The method according to claim 1, further comprising:
sending availability information of the first measurement configured to determine the collection request to the first node.

6. The method according to claim 5, wherein the availability information comprises at least one of:
a start indication of the first measurement being activated;
a stop indication of the first measurement being activated;
a cell identifier of a specific cell corresponding to information fed back by the first measurement being activated;
a measurement identifier of the first measurement being activated;
a terminal device identifier of the terminal device for which the first measurement is activated; or
content information of the first measurement being activated.

7. The method according to claim 5, further comprising:
receiving an availability request of the first measurement sent by the first node, wherein the availability request is configured to indicate the second node to obtain the availability information, and send the availability information to the first node.

8. The method according to claim 7, wherein the availability request comprises at least one of:
information indicating measurement availability information;
indicating that the first node has an artificial intelligence (AI) function;
indicating that an artificial intelligence (AI) function of the first node is turned on;
indicating that an artificial intelligence (AI) function of the first node is turned off; or
a feedback condition of measurement availability information.

9. The method according to claim 7, wherein at least one of the collection request, the collection feedback, the availability information, and the availability request is transmitted using a signaling message associated with a terminal device or using a signaling message not associated with a terminal device.

10. (canceled)

11. The method according to claim 1, wherein the first node is a centralized unit-control plane (CU-CP) and the second node is a centralized unit-user plane (CU-UP); or
wherein the first node is a master node (MN) and the second node is a secondary node (SN); or
wherein the first node is a centralized unit (CU) and the second node is a distributed unit (DU).

12-13. (canceled)

14. A method for obtaining measurement, performed by a first node, comprising:
sending a collection request of a first measurement to a second node; and
receiving collection feedback of the first measurement sent by the second node, wherein the first measurement is configured by a third node and activated on the second node, and the first node is different from the third node.

15. The method according to claim 14, wherein the first measurement comprises at least one of:
management-based minimization of drive tests (MDT);
cell traffic trace; or
user equipment (UE) trace; or
wherein the collection request comprises at least one of:
a start collection indication:
a stop collection indication;
time information for collection;
a cell identifier of a specific cell needing to be collected;
a measurement identifier of the first measurement needing to be collected;
a terminal device identifier of a terminal device needing to be collected;
measurement content of the first measurement needing to be collected; or
a reporting manner of a measurement report; or
wherein the collection feedback comprises a measurement report of the first measurement, and the measurement report comprises at least one of:
a measurement identifier corresponding to a measurement result;
a terminal device identifier of a terminal device corresponding to a measurement result;
a measurement result;
a cell identifier of a specific cell corresponding to a measurement result;
a measurement start time corresponding to a measurement result; or
a measurement end time corresponding to a measurement result.

16. The method according to claim 14, further comprising:
according to the collection feedback, performing at least one of:
model training;
model reasoning; or
model performance feedback.

17-18. (canceled)

19. The method according to claim 14, further comprising:
receiving availability information of the first measurement configured to determine the collection request sent by the second node.

20. The method according to claim 19, wherein the availability information comprises at least one of:
a start indication of the first measurement being activated;
a stop indication of the first measurement being activated;
a cell identifier of a specific cell corresponding to information fed back by the first measurement being activated;
a measurement identifier of the first measurement being activated;
a terminal device identifier of the terminal device for which the first measurement is activated; or
content information of the first measurement being activated.

21. The method according to claim 19, further comprising:
sending an availability request of the first measurement to the second node, wherein the availability request is configured to indicate the second node to obtain the availability information, and send the availability information to the first node.

22. The method according to claim 21, wherein the availability request comprises at least one of:
information indicating measurement availability information;
indicating that the first node has an artificial intelligence (AI) function;
indicating that an artificial intelligence (AI) function of the first node is turned on;
indicating that an artificial intelligence (AI) function of the first node is turned off; or
a feedback condition of measurement availability information.

23. The method according to claim 21, wherein at least one of the collection request, the collection feedback, the availability information, and the availability request is transmitted using a signaling message associated with a terminal device or using a signaling message not associated with a terminal device.

24. (canceled)

25. The method according to claim 14, wherein the first node is a centralized unit-control plane (CU-CP) and the second node is a centralized unit-user plane (CU-UP); or
wherein the first node is a master node (MN) and the second node is a secondary node (SN); or
wherein the first node is a centralized unit (CU) and the second node is a distributed unit (DU).

26-29. (canceled)

30. A communication device, comprising:
a processor; and
a memory;
storing a computer program executable by the processor,
wherein the processor is configured to:
receive a collection request of a first measurement sent by a first node; and
send collection feedback of the first measurement to the first node, wherein the first measurement is initiated and configured by a third node and activated on a second node, and the first node is different from the third node.

31-32. (canceled)

33. A communication device, comprising:
a processor; and
a memory storing a computer program executable by the processor,
wherein the processor is configured to perform the method according to claim 14.
